(19) United States
(12) Patent Application Publication
(10) Pub. No.: US 2026/0206578 A1
(43) Pub. Date: Jul. 16, 2026

(54) SEMICONDUCTOR DEVICE AND METHOD OF DESIGNING THE SAME

(71) Applicant: Renesas Electronics Corporation, Tokyo (JP)

(72) Inventor: Masahiro HASEGAWA, Tokyo (JP)

(21) Appl. No.: 19/441,357

(22) Filed: Jan. 6, 2026

(30) Foreign Application Priority Data
Jan. 16, 2025 (JP) 2025-006155

(51) Int. Cl. H10W 20/40; G06F 30/392; H10D 84/83; G06F 115/08; G06F 119/06

(52) U.S. Cl. CPC H10W 20/495; G06F 30/392; H10D 84/835; G06F 2115/08; G06F 2119/06

(57) ABSTRACT

To improve the performance of the differential circuit. Additionally, to suppress the increase in development cost and development period without causing characteristic variations in the pair elements. The plurality of MOS units 0Q are composed of at least one MOSFET, each having the same structure, and are arranged adjacent to each other on the main surface of the semiconductor substrate in plan view. The plurality of MOS units 0Q include MOS unit 1Q and MOS unit 2Q, which constitute part of the differential circuit as pair elements, and MOS unit 3Q, which functions as a capacitive element.

### CROSS-REFERENCE TO RELATED APPLICATIONS

The disclosure of Japanese Patent Application No. 2025-006155 filed on January 16, 2025, including the specification, drawings and abstract is incorporated herein by reference in its entirety.

### BACKGROUND

The present invention relates to a semiconductor device and a method for designing the same, particularly to a semiconductor device comprising paired elements that form part of a differential circuit and a method for designing the same.

### There are disclosed techniques listed below.

Japanese Unexamined Patent Application Publication No. 2005-223245

In the topmost wiring layer of the semiconductor chip, multiple wirings are formed, some of which are used as pad electrodes for connecting bump electrodes or wires. For example, Patent Document 1 discloses a technique for forming n-type MOSFETs (Metal Oxide Semiconductor Field Effect Transistors) and p-type MOSFETs beneath the pad electrodes. Some of these MOSFETs are used as capacitive elements that constitute decoupling capacitance.

### SUMMARY

Typically, the wiring thickness of the topmost wiring layer, such as pad electrodes, is the thickest among the wirings formed on the semiconductor chip. When MOSFETs are formed beneath such thick wirings, it is known that the stress from these wirings can cause variations in the characteristics of the MOSFETs. For example, the stress from the wiring of the topmost wiring layer can cause the drain saturation current (IDsat) of the MOSFET to vary by about ±5%.

The semiconductor chip is equipped with analog IP (Intellectual Property) as a circuit function block with a specific role. The paired elements used in part of the differential circuit of the analog IP are configured by a pair of MOSFETs with the same structure to obtain the same characteristics. Therefore, when characteristic variations occur in one of the MOSFETs, the sensitivity of the differential circuit changes significantly. To avoid such characteristic variations, it is effective to arrange the wiring of the topmost wiring layer so as not to cover the paired elements.

Upper layer wirings, such as those in the topmost wiring layer, are often arranged in the latter part of the design. Additionally, the layout of the wiring in the topmost wiring layer is also changed according to the specifications of the package for each product. After a layout change, when the paired elements are covered by the wiring of the topmost wiring layer, it becomes necessary to move the paired elements, requiring a redesign of the floor plan around the analog IP. Therefore, there is a problem of increased development costs and development time. Furthermore, as the process miniaturization progresses, the standards for analog IP become stricter, making it increasingly difficult to meet the standards for analog IP.

Therefore, there is a demand for technology that can suppress the increase in development costs and development time without causing characteristic variations in the paired elements. Additionally, technology that can easily meet the standards for analog IP even as process miniaturization progresses is sought.

On the other hand, in analog IPs that require high-speed operation, decoupling capacitance is placed within the analog IP to stabilize the power supply waveform. For example, decoupling capacitance is electrically connected between the power supply wiring and the ground wiring used in the differential circuit. In this case, when the decoupling capacitance is placed far from the paired elements, the wiring resistance increases, causing the amplitude of the power supply waveform to increase and the responsiveness of the decoupling capacitance to deteriorate. Therefore, when the decoupling capacitance can be placed near the paired elements, the wiring resistance between the paired elements and the decoupling capacitance decreases, improving the performance of the differential circuit.

To minimize wiring resistance, measures such as making the power supply wiring a mesh structure in a higher wiring layer may be taken. However, other circuits are also formed around the paired elements, making it difficult to always use a mesh structure for the power supply wiring. Additionally, since the area of the decoupling capacitance is relatively large, it is difficult to always place the decoupling capacitance near the paired elements.

Other problems and novel features will become apparent from the description of this specification and the accompanying drawings.

The typical ones of the embodiments disclosed in the present application will be briefly described as follows.

A semiconductor device in one embodiment includes a semiconductor substrate having a first surface, and a plurality of MOS units each composed of at least one MOSFET, each having the same structure, and arranged adjacent to each other on the first surface of the semiconductor substrate in plan view when viewed from above. The plurality of MOS units includes a first MOS unit and a second MOS unit that forms part of a differential circuit as paired elements, and a third MOS unit that functions as a capacitive element.

A method of designing a semiconductor device in one embodiment includes: (a) preparing a plurality of MOS units each composed of at least one MOSFET, each having the same structure, and arranged adjacent to each other on the first surface of the semiconductor substrate in plan view when viewed from above; (b) selecting a first MOS unit and a second MOS unit from the plurality of MOS units that form part of a differential circuit as paired elements; and (c) after step (b), selecting a third MOS unit that functions as a capacitive element from the remaining plurality of MOS units.

According to one embodiment, the performance of the differential circuits can be improved. Additionally, the increase in development costs and development time can be suppressed without causing characteristic variations in the paired elements.

### BRIEF DESCRIPTION OF THE DRAWINGS

FIG. 1 is a plan view showing a semiconductor device in the first embodiment.

FIG. 2 is an equivalent circuit diagram showing an analog IP including a differential circuit in the first embodiment.

FIG. 3 is a plan view showing the layout of pad electrodes and paired elements in the first embodiment.

FIG. 4 is a plan view showing the state before and after the design change of the pad electrodes in the first embodiment.

FIG. 5 is a plan view showing the layout of pad electrodes and paired elements in Example 1.

FIG. 6 is a schematic diagram showing the wiring resistance between the paired elements and the decoupling capacitance in Example 2.

FIG. 7 is a flowchart showing the method for designing a semiconductor device in the first embodiment.

FIG. 8 is a plan view showing the layout of pad electrodes and multiple MOS units in the first embodiment.

FIG. 9 is a plan view showing the layout of pad electrodes and multiple MOS units in the first embodiment.

FIG. 10 is a plan view for explaining the number of MOS units that can be arranged in the first embodiment.

FIG. 11 is a cross-sectional view showing a semiconductor device in the first embodiment.

FIG. 12 is a cross-sectional view showing MOSFETs and capacitive elements in the first embodiment.

FIG. 13 is a cross-sectional view showing MOSFETs and capacitive elements in the first embodiment.

FIG. 14 is a perspective view showing an example of the structure of a MOSFET in the first modified example.

FIG. 15 is a plan view showing the state before and after the design change of the pad electrodes in the second modified example.

FIG. 16 is an equivalent circuit diagram showing an analog IP including a differential circuit in the second embodiment.

FIG. 17 is a plan view showing the layout of pad electrodes and paired elements in the second embodiment.

FIG. 18 is a plan view showing the layout of pad electrodes and multiple MOS units in the second embodiment.

FIG. 19 is a plan view showing the layout of pad electrodes and multiple MOS units in the second embodiment.

FIG. 20 is a plan view showing the layout of multiple MOS units in the second embodiment.

FIG. 21 is a cross-sectional view showing a semiconductor device in the second embodiment.

FIG. 22 is an equivalent circuit diagram showing an analog IP including a differential circuit in the third embodiment.

FIG. 23 is a plan view showing the layout of pad electrodes and paired elements in the third embodiment.

FIG. 24 is a plan view showing the layout of pad electrodes and multiple MOS units in the third embodiment.

FIG. 25 is a plan view showing the layout of pad electrodes and multiple MOS units in the third embodiment.

FIG. 26 is a plan view showing the layout of MOS units that become paired elements in the third embodiment.

FIG. 27 is a plan view showing the layout of MOS units that become paired elements in the third embodiment.

FIG. 28 is a plan view showing the layout of MOS units that become capacitive elements in the third embodiment.

FIG. 29 is a cross-sectional view showing a semiconductor device in the third embodiment.

FIG. 30 is a plan view showing the layout of pad electrodes and multiple MOS units in the fourth embodiment.

FIG. 31 is a plan view showing the layout of multiple MOS units in the fifth embodiment.

FIG. 32 is a plan view showing the layout of MOS units that are unused in the fifth embodiment.

FIG. 33 is an equivalent circuit diagram in the case of uniform arrangement.

FIG. 34 is an equivalent circuit diagram in the case of non-uniform arrangement.

### DETAILED DESCRIPTION

Hereinafter, embodiments are described in detail with reference to the drawings. In all the drawings for explaining the embodiments, members having the same functions are denoted by the same reference numerals, and repetitive descriptions thereof are omitted. In the following embodiments, descriptions of the same or similar parts will not be repeated in principle except if particularly necessary.

Further, the X direction, Y direction, and Z direction described in the present application intersect and are orthogonal to each other. In the present application, the Z direction is described as the vertical direction, depth direction, or thickness direction of a structure. Also, expressions such as "plan view" used in the present application mean viewing the "plane" constituted by the X direction and Y direction from the Z direction. Furthermore, expressions such as "plan view" mean viewing the main surface of the semiconductor substrate SUB from above.

### First Embodiment

### Plan Layout of Semiconductor Device

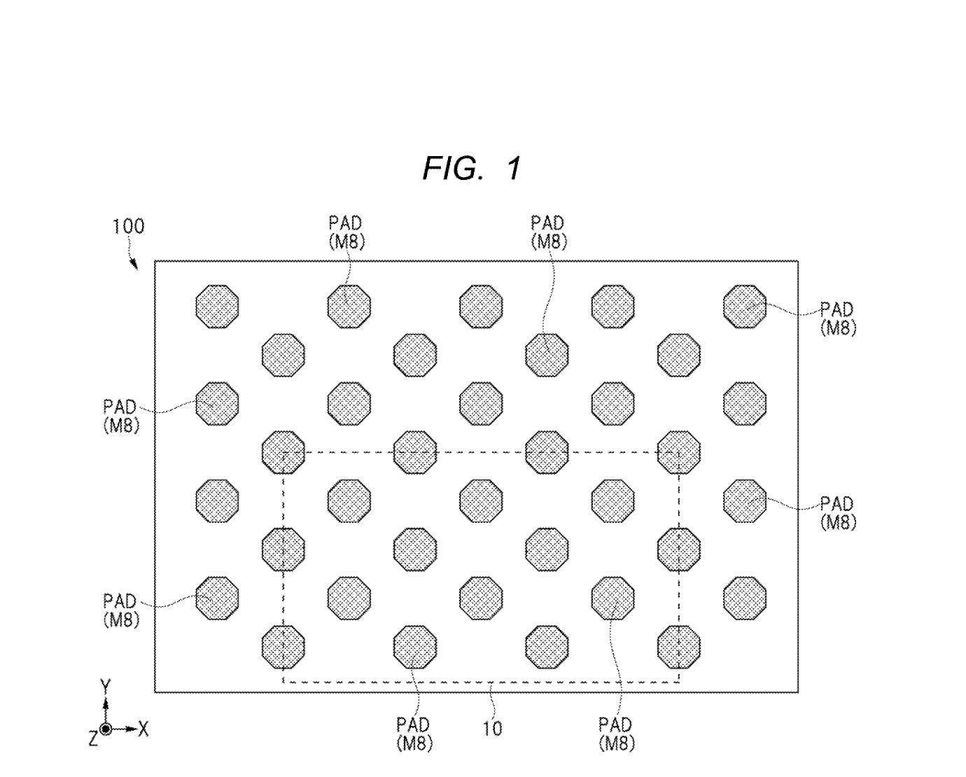

Below, using FIG. 1 to FIG. 13, the semiconductor device 100 (semiconductor chip) in the first embodiment will be described.

FIG. 1 is a plan view of the semiconductor device 100 as seen from above. As shown in FIG. 1, the semiconductor device 100 includes a plurality of pad electrodes PAD formed on the uppermost wiring layer. The plurality of pad electrodes PAD is arranged in a staggered configuration. The number and arrangement of the plurality of pad electrodes PAD shown in FIG. 1 are examples and can be changed as appropriate. By connecting an external connection member such as a bump electrode to the pad electrode PAD, the semiconductor device 100 can be electrically connected to another semiconductor chip or wiring board.

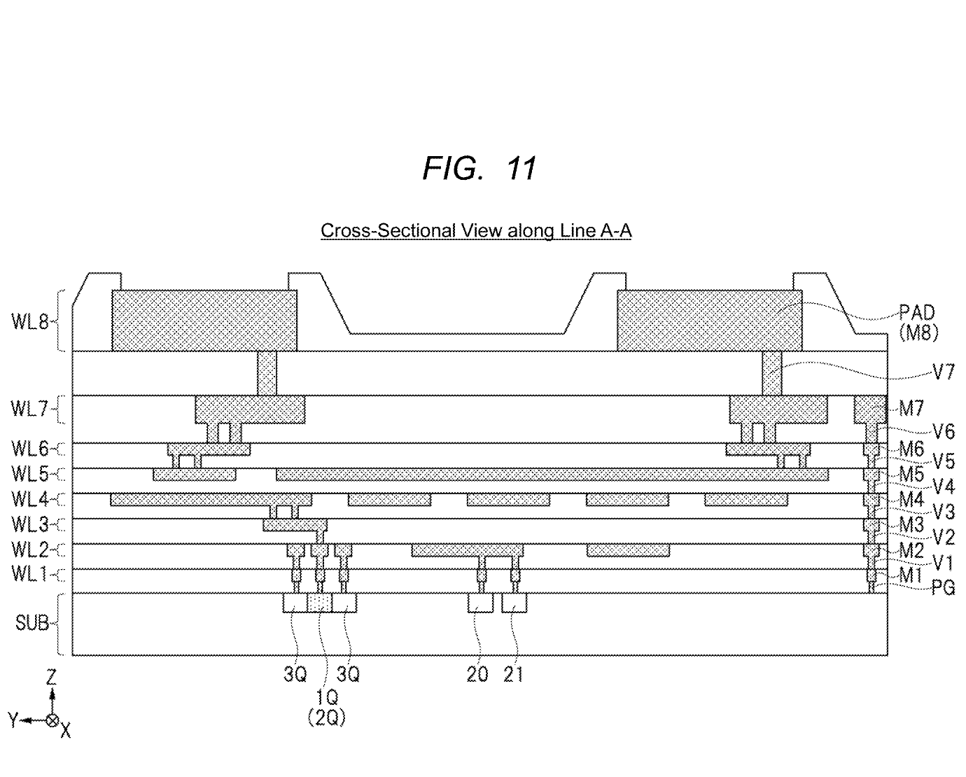

As shown in FIG. 11, the semiconductor device 100 includes a multilayer wiring layer consisting of wiring layers WL1 to WL8, with wiring layer WL8 constituting the uppermost wiring layer. A plurality of wiring M8 is formed on the wiring layer WL8. The pad electrode PAD is part of the plurality of wirings M8.

Also, as shown in FIG. 1, the semiconductor device 100 includes an analog IP10 as a circuit function block with a specific role.

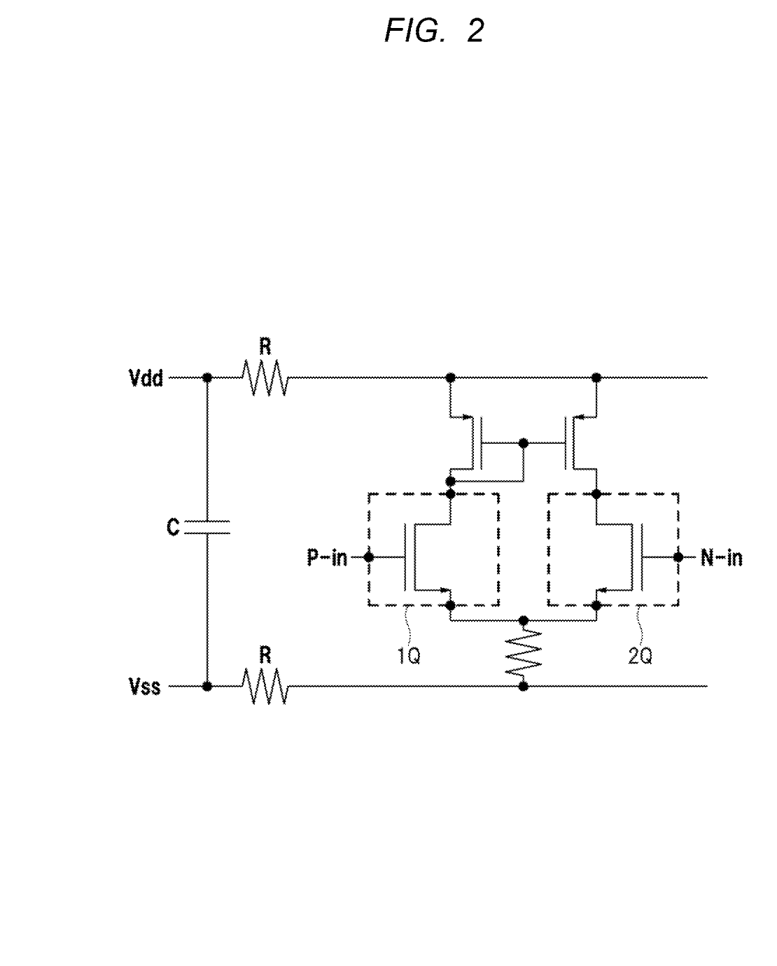

FIG. 2 shows a BGR (Bandgap Reference) circuit as a differential circuit included in the analog IP10 in the first embodiment. MOS units 1Q and 2Q constitute part of the differential circuit as paired elements. In the first embodiment, MOS units 1Q and 2Q are each composed of one n-type MOSFET.

The differential circuit uses power supply wiring Vdd and ground wiring Vss, and FIG. 2 shows a decoupling capacitor C electrically connected between the power supply wiring Vdd and the ground wiring Vss, and a wiring resistance R between the decoupling capacitor C and the paired elements.

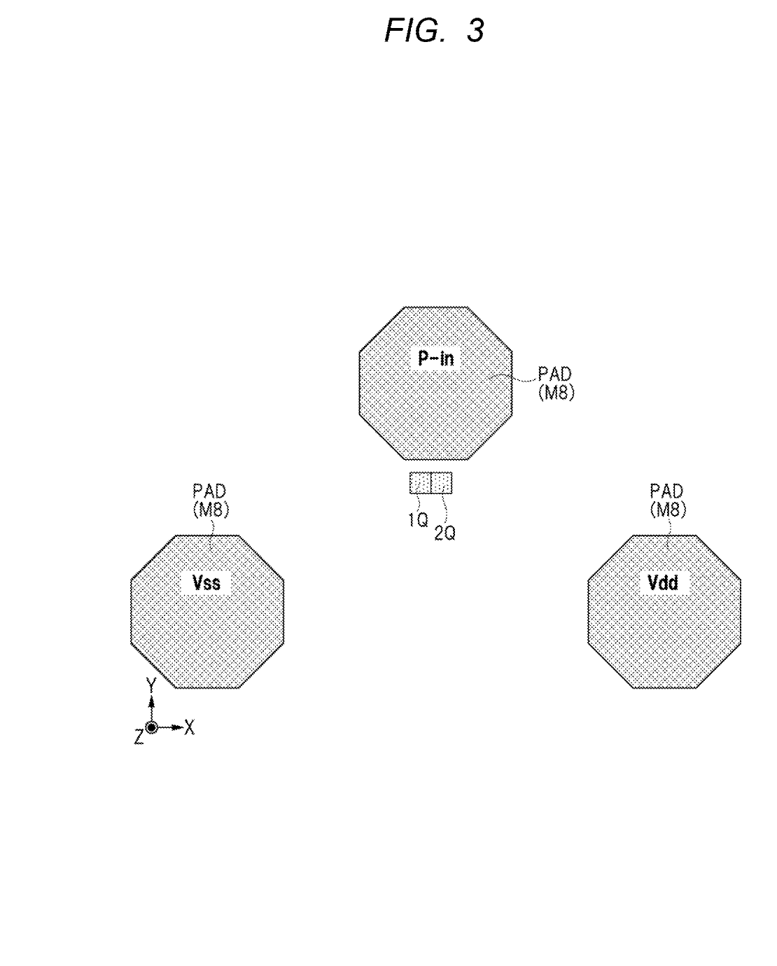

FIG. 3 is an enlarged plan view of a part of FIG. 1 within the analog IP10, showing the positional relationship between the plurality of pad electrodes PAD and the MOS units 1Q and 2Q. To avoid characteristic variations as paired elements, the MOS units 1Q and 2Q are arranged such that the coverage rate of MOS unit 1Q covered by the pad electrode PAD is the same as the coverage rate of MOS unit 2Q covered by the pad electrode PAD in plan view.

Here, MOS units 1Q and 2Q are not covered by the pad electrode PAD (wiring M8). However, when the coverage rate of MOS unit 1Q is the same as that of MOS unit 2Q, all of MOS unit 1Q and all of MOS unit 2Q may be covered by wiring M8, or part of MOS unit 1Q and part of MOS unit 2Q may be covered by wiring M8.

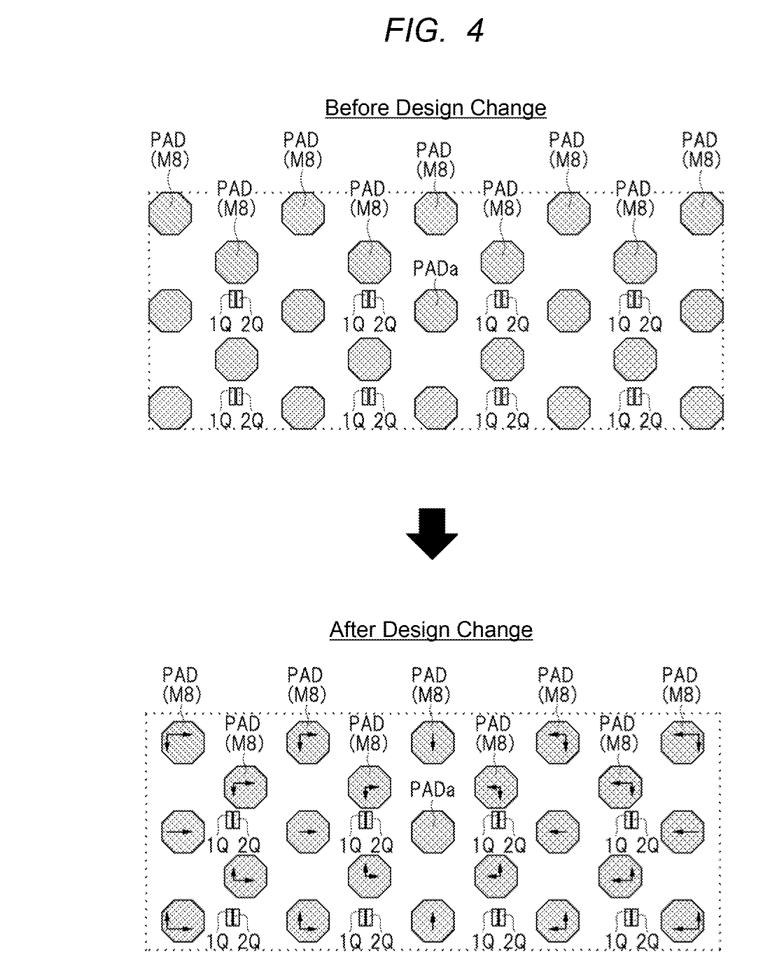

Here, as shown in FIG. 4, for example, due to specification changes in the package for each product, the pitch between each pad electrode PAD (the pitch between each wiring M8) may be changed. In that case, since the arrangement positions of MOS units 1Q and 2Q are not changed, a misalignment occurs in the positional relationship between the pad electrode PAD and MOS units 1Q and 2Q. In FIG. 4, the pitch is uniformly narrowed with respect to the reference pad electrode PADa, and further away from the reference pad electrode PADa, the greater the movement amount of the pad electrode PAD. That is, the further away from the reference pad electrode PADa, the greater the misalignment in the positional relationship between the pad electrode PAD and MOS units 1Q and 2Q.

For example, when a pad electrode PAD that is one pitch away from the reference pad electrode PADa in the X or Y direction moves 5μm toward the reference pad electrode PADa, a pad electrode PAD that is two pitches away from the reference pad electrode PADa in the X or Y direction moves 10μm toward the reference pad electrode PADa.

As a result, the coverage rate of MOS unit 1Q and the coverage rate of MOS unit 2Q change, and for example, the coverage rate of MOS unit 1Q and the coverage rate of MOS unit 2Q may become different values. As a countermeasure in such cases, the design method of Example 1 and the design method of the first embodiment will be described. Additionally, as a consideration regarding the arrangement method of decoupling capacitor C, Example 2 will also be described.

### Design Method of Example 1

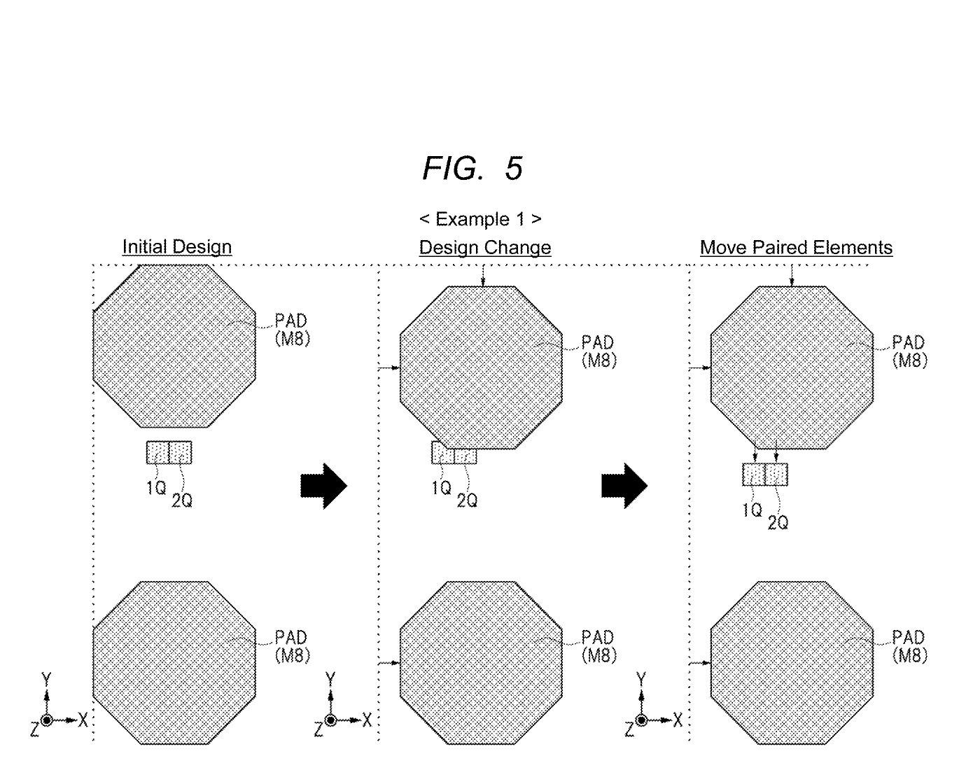

In Example 1, first, as shown in the "Initial Design" of FIG. 5, the pitch between each wiring M8 is designed so that MOS units 1Q and 2Q are not covered by the pad electrode PAD (wiring M8), and the layout of multiple wiwiring8 is performed.

Next, as shown in the "Design Change" of FIG. 5, the pitch between each wiring M8 may be changed. Then, part of MOS unit 1Q and part of MOS unit 2Q may be unevenly covered by the pad electrode PAD. That is, the coverage rate of MOS unit 1Q may become a different value from the coverage rate of MOS unit 2Q.

In such cases, as shown in "Move Paired Elements" of FIG. 5, the arrangement positions of MOS units 1Q and 2Q are changed to avoid characteristic variations as paired elements. However, this requires redesigning the floor plan around the analog IP10, increasing development costs and time. For example, although only the paired elements (MOS units 1Q, 2Q) are illustrated here, other elements used in the analog IP10 are arranged around the paired elements. Since the arrangement positions of those other elements are also changed, enormous development costs and time are required.

### Example 2

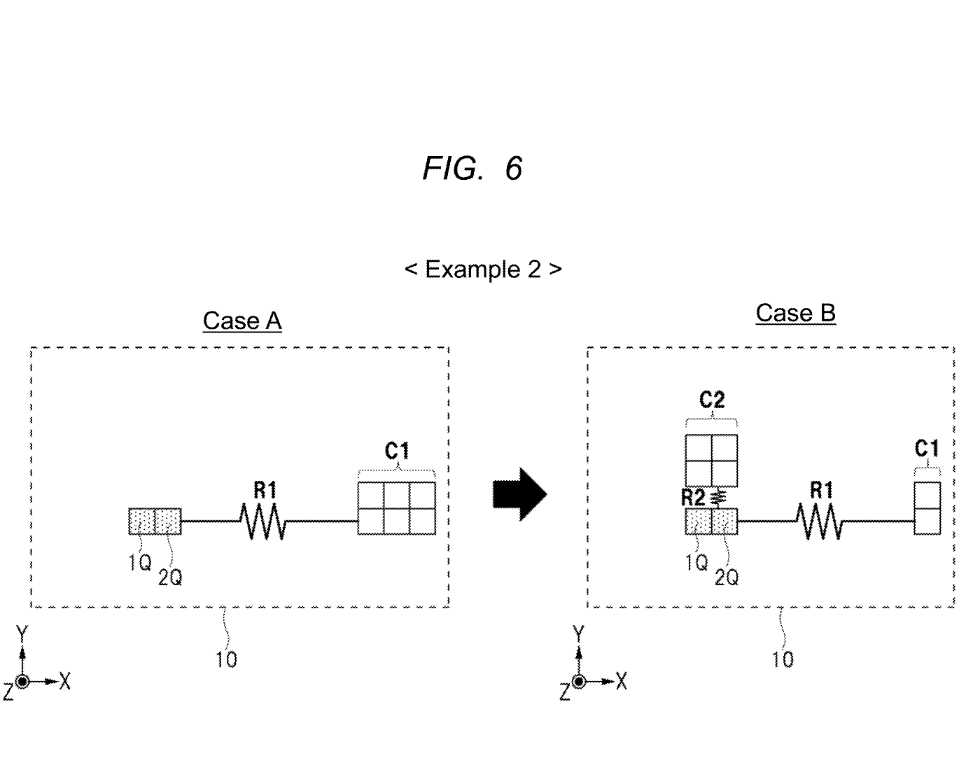

The capacitive element functioning as the decoupling capacitor C is formed within the analog IP10. In Example 2, as shown in "Case A" of FIG. 6, the capacitive element C1 functioning as the decoupling capacitor C is placed relatively far from MOS units 1Q and 2Q. In this case, since the resistance component R1 is relatively large, the overall wiring resistance R becomes large. Therefore, the amplitude of the power supply waveform increases, and the responsiveness of the decoupling capacitor C deteriorates.

As shown in "Case B" of FIG. 6, when part or all of the capacitive element C1 can be placed as capacitive element C2 relatively close to MOS units 1Q and 2Q, the resistance component R2 is smaller compared to the resistance component R1, so the overall wiring resistance R becomes smaller.

For example, when all of the capacitive element C1 with a total capacitance value of 10pF is replaced with capacitive element C2, and the difference between the resistance components R1 and R2 is about 500mΩ, a difference of about 10mV occurs in the amplitude of the power supply waveform.

### Design Method of the First Embodiment

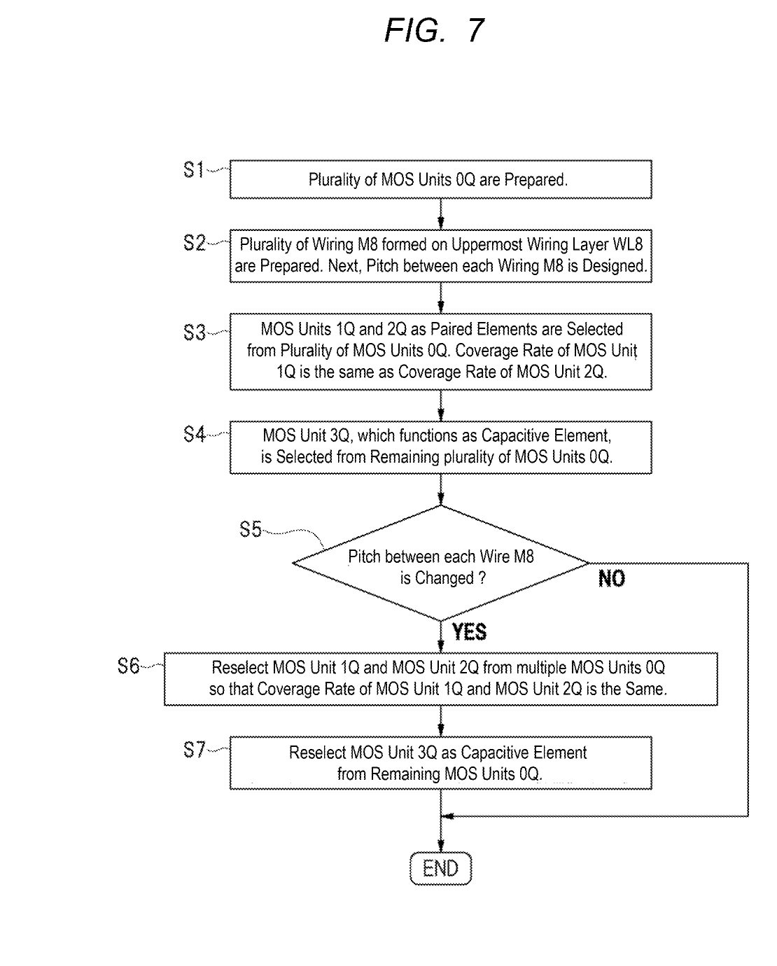

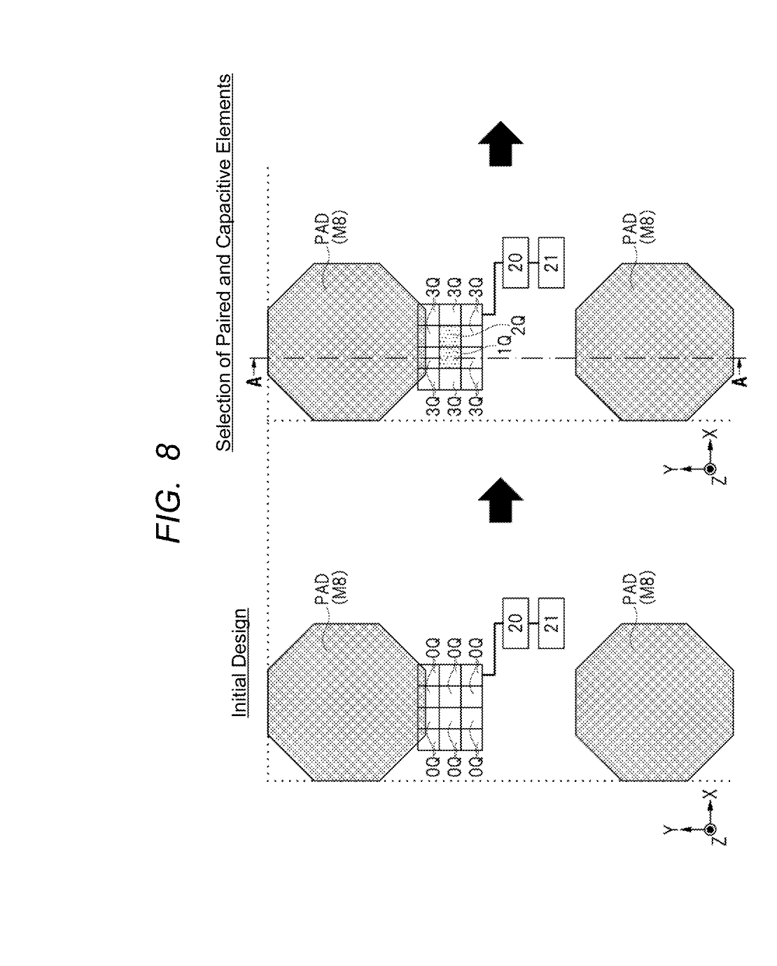

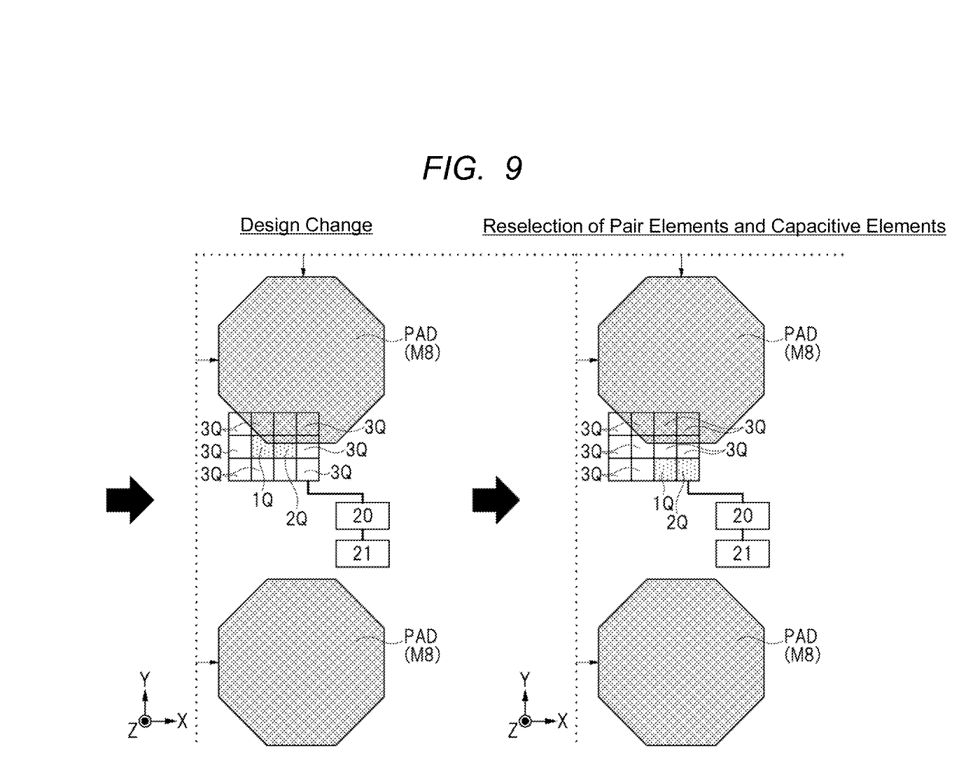

Below, using FIG. 7, FIG. 8, and FIG. 9, the design method of the semiconductor device 100 in the first embodiment will be described. The design method of the semiconductor device 100 includes steps S1 to S7 as shown in FIG. 7.

First, as shown in "Initial Design" of FIG. 8, in step S1, a plurality of MOS units 0Q arranged adjacent to each other on the main surface of the semiconductor substrate are prepared in plan view. The plurality of MOS units 0Q are each composed of at least one MOSFET and have the same structure. In the first embodiment, the plurality of MOS units 0Q are each composed of one n-type MOSFET.

In step S2, a plurality of wiring M8 formed on the uppermost wiring layer (wiring layer WL8) of the multilayer wiring layer formed above the plurality of MOS units 0Q are prepared. Here, among the plurality of wiring M8, the wiring M8 used as the pad electrode PAD is prepared. Next, the pitch between each wiring M8 is designed, and the layout of multiple wiring M8 is performed.

Next, as shown in "Selection of Paired and Capacitive Elements" of FIG. 8, in step S3, MOS units 1Q and 2Q, which constitute part of the differential circuit as paired elements, are selected from the plurality of MOS units 0Q. Here, MOS units 1Q and 2Q are selected such that the coverage rate of MOS unit 1Q covered by wiring M8 in plan view is the same as the coverage rate of MOS unit 2Q covered by wiring M8 in plan view.

In this way, in the first embodiment, by preparing a plurality of MOS units 0Q in advance as candidates for the paired elements (MOS units 1Q, 2Q), MOS units 1Q and 2Q with the same coverage rate can be selected regardless of the layout situation of the plurality of wirings M8. Therefore, characteristic variations of the paired elements do not occur. Also, as in Example 1, since it is not necessary to layout the wiring M8 avoiding MOS units 1Q and 2Q, the layout flexibility of the wiring M8 can be improved.

In step S4, MOS unit 3Q, which functions as a capacitive element, is selected from the remaining plurality of MOS units 0Q. MOS unit 3Q is used as the decoupling capacitor C. In the first embodiment, all MOS units 0Q except for MOS units 1Q and 2Q are selected as MOS unit 3Q.

After that, as shown in "Design Change" of FIG. 9, the pitch between each wiring M8 may be changed. In step S5, when the pitch between each wire M8 is changed (YES), reselect MOS unit 1Q and MOS unit 2Q in step S6. When the pitch between each wire M8 is not changed (NO), there is no need to perform steps S6 and S7.

As shown in FIG. 9, "Reselection of Pair Elements and Capacitive Elements," in step S6, reselect MOS unit 1Q and MOS unit 2Q from multiple MOS units 0Q so that the coverage rate of MOS unit 1Q and MOS unit 2Q is the same.

In step S7, reselect MOS unit 3Q from the remaining MOS units 0Q. In step S7, as in step S4, reselect all MOS units 0Q except MOS unit 1Q and MOS unit 2Q as MOS unit 3Q.

Thus, in the first embodiment, even when the pitch between each wire M8 is changed, MOS unit 1Q and MOS unit 2Q can be reselected, preventing characteristic variations of the pair elements. Moreover, there is no need to change the arrangement position of other elements used in analog IP10, thus suppressing the increase in development cost and development period.

Note that even when the pitch between each wire M8 is changed in step S5, when the coverage rate of MOS unit 1Q is the same as that of MOS unit 2Q, steps S6 and S7 may not be performed. That is, when the coverage rate of MOS unit 1Q differs from that of MOS unit 2Q, reselect MOS unit 1Q and MOS unit 2Q in step S6, and reselect MOS unit 3Q in step S7.

In the first embodiment, select the remaining MOS units 0Q as MOS unit 3Q and use MOS unit 3Q as a capacitive element for decoupling capacitance C. Since a capacitive element for decoupling capacitance C can be placed near the pair elements MOS unit 1Q and MOS unit 2Q, the wiring resistance R between the pair elements and decoupling capacitance C decreases, the amplitude of the power supply waveform becomes smaller, and the responsiveness of decoupling capacitance C improves. In other words, the performance of the differential circuit can be improved.

Furthermore, when such MOS unit 3Q is not provided, it is necessary to place capacitive element C1 at a location relatively far from MOS unit 1Q and MOS unit 2Q, as shown in "Case A" in FIG. 6. In the first embodiment, since part or all of capacitive element C1 can be replaced by MOS unit 3Q, the area intended for capacitive element C1 can be reduced, and the area of analog IP10 can be reduced. Therefore, semiconductor device 100 can be miniaturized.

When the capacitive element required for decoupling capacitance C is insufficient with only MOS unit 3Q, place capacitive element C1 at a location relatively far from MOS unit 1Q and MOS unit 2Q to compensate for the deficiency with capacitive element C1.

In the first embodiment, to select MOS unit 1Q and MOS unit 2Q from multiple MOS units 0Q, prepare control circuit 20 and register 21 electrically connected to multiple MOS units 0Q at the stage of step S1. Also, at the stage of step S1, prepare power supply wiring Vdd and ground wiring Vss used in the differential circuit.

At the time the layout of wire M8 is determined, the coverage rate of each of the multiple MOS units 0Q is determined. Register 21 stores information regarding the coverage rate covered by wire M8 in plan view for each of the multiple MOS units 0Q. In steps S3 and S6, control circuit 20 automatically selects MOS unit 1Q and MOS unit 2Q from multiple MOS units 0Q based on the information in register 21, so that the coverage rate covered by wire M8 in plan view is the same. Furthermore, control circuit 20 automatically selects all MOS units 0Q except MOS unit 1Q and MOS unit 2Q as MOS unit 3Q.

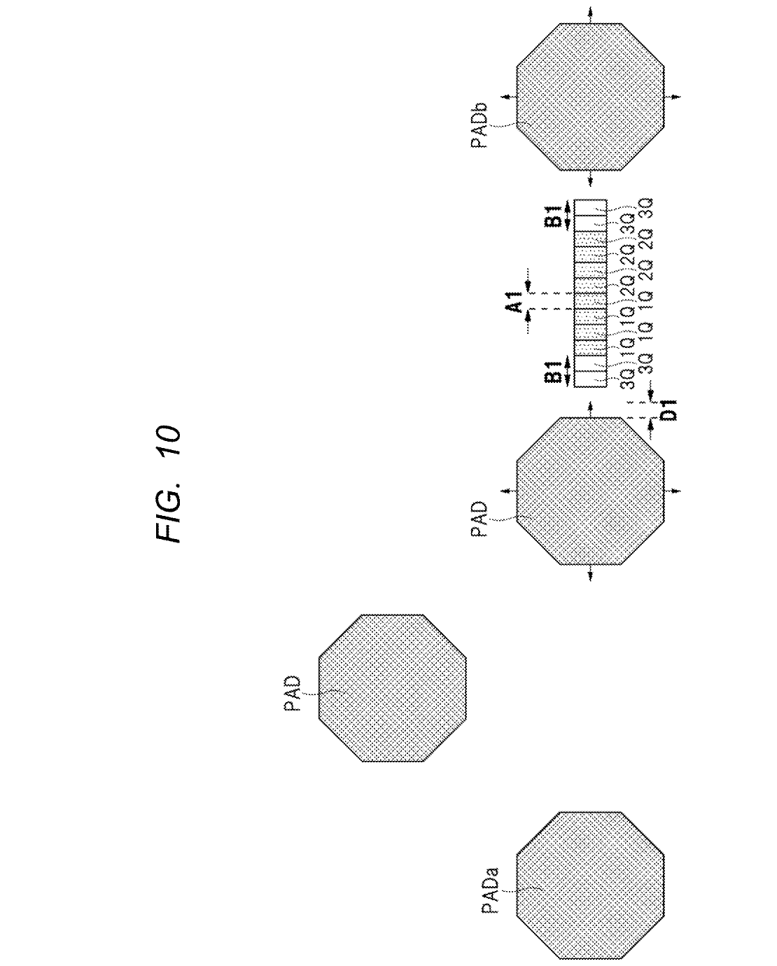

Below, using FIG. 10, the number of MOS units that can be arranged between each pad electrode PAD will be explained. The number of MOS units that can be arranged varies depending on the distance from the reference pad electrode PADa.

The size of one MOS unit is defined as A1. When the number of MOS units 3Q other than MOS units 1Q and 2Q is N, the area B1 where multiple MOS units 3Q are arranged can be expressed as "B1=A1×N". Also, let the shift amount between each pad electrode PAD during pitch change be D1, and the number of pad electrodes PAD from the reference pad electrode PADa to the farthest pad electrode PADb be P. Note that pad electrodes PAD arranged in a staggered pattern are counted as 0.5. Let the margin with the pair element at the pad electrode PAD boundary be A1/2.

The maximum shift amount M of the pad electrode PAD viewed from the reference pad electrode PADa is "M=D1×P+(A1/2)". When the pad electrode PAD moves, the coverage between the pad electrode PAD and the pair element can be adjusted by arranging area B1, where M<B1, in the direction where the pair element may be covered by the pad electrode PAD. Note that such a relationship is similar in other embodiments described later.

### Cross-Sectional Structure of Semiconductor Device

Below, using FIGS. 11 to 13, the cross-sectional structure of semiconductor device 100 will be explained. FIG. 3 is a cross-sectional view along line A-A shown in FIG. 2.

As shown in FIG. 11, semiconductor device 100 includes semiconductor substrate SUB, multiple MOS units 1Q, 2Q, 3Q formed on the main surface of semiconductor substrate SUB, and a multilayer wiring layer formed above multiple MOS units 1Q, 2Q, 3Q.

The multilayer wiring layer has wiring layers WL1 to WL8. Wiring layers WL1 to WL8 each have wires M1 to M8 formed. The wiring thickness of wire M8 is thicker than the wiring thickness of wires M1 to M7 formed in the multilayer wiring layer. Note that while an example of an 8-layer multilayer wiring layer is illustrated here, the number of layers in the multilayer wiring layer can be changed as appropriate.

Multiple MOS units 1Q, 2Q, 3Q and wire M1 are electrically connected by plug PG. Wires M1 to M7 are each electrically connected by vias V1 to V6. Wire M7 and wire M8 are electrically connected by via V7.

Plug PG is formed mainly of a tungsten film, for example. Wires M1 to M7 and vias V1 to V6 are each wiring of a damascene structure or dual damascene structure, formed mainly of a copper film, for example. Via V7 is formed mainly of a tungsten film, for example. Wire M8 is formed mainly of a patterned aluminum alloy film.

For example, as shown in FIG. 6, the connection from MOS unit 1Q and MOS unit 2Q to capacitive element C1 is made not only through lower layer wiring like wire M1 and wire M2 but also through upper layer wiring like wire M7, making resistance component R1 likely to increase. On the other hand, the connection from MOS unit 1Q and MOS unit 2Q to MOS unit 3Q can be made through lower layer wiring like wire M1 and wire M2. By using MOS unit 3Q as capacitive element C2, resistance component R2 is small, allowing the overall wiring resistance R to be reduced.

### Cross-Sectional Structure of MOSFET

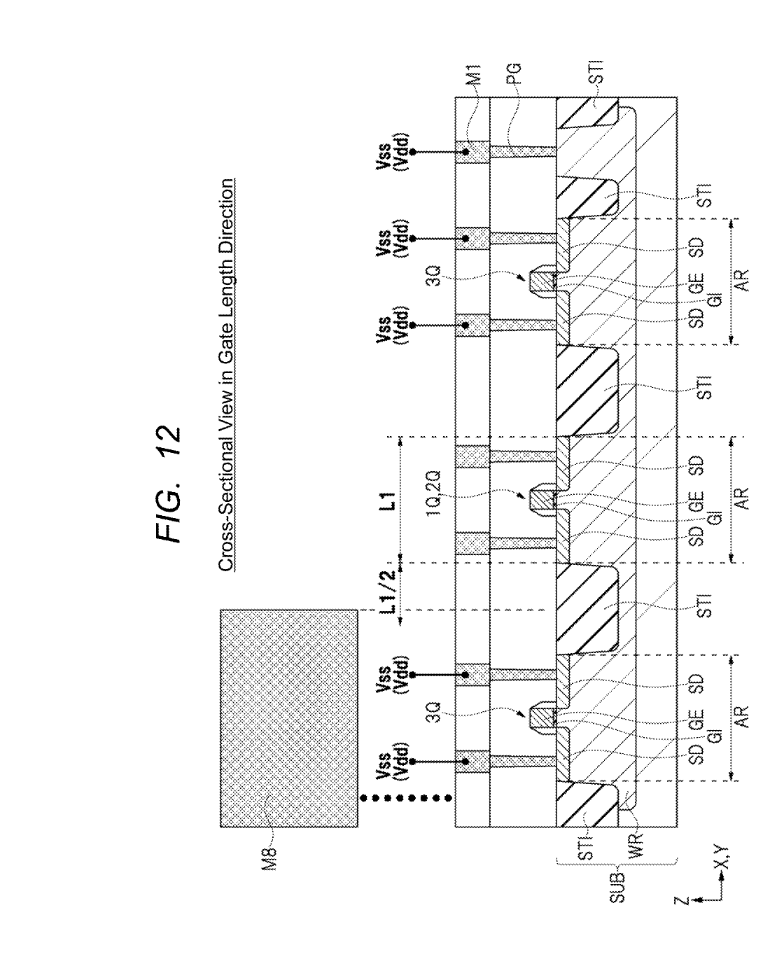

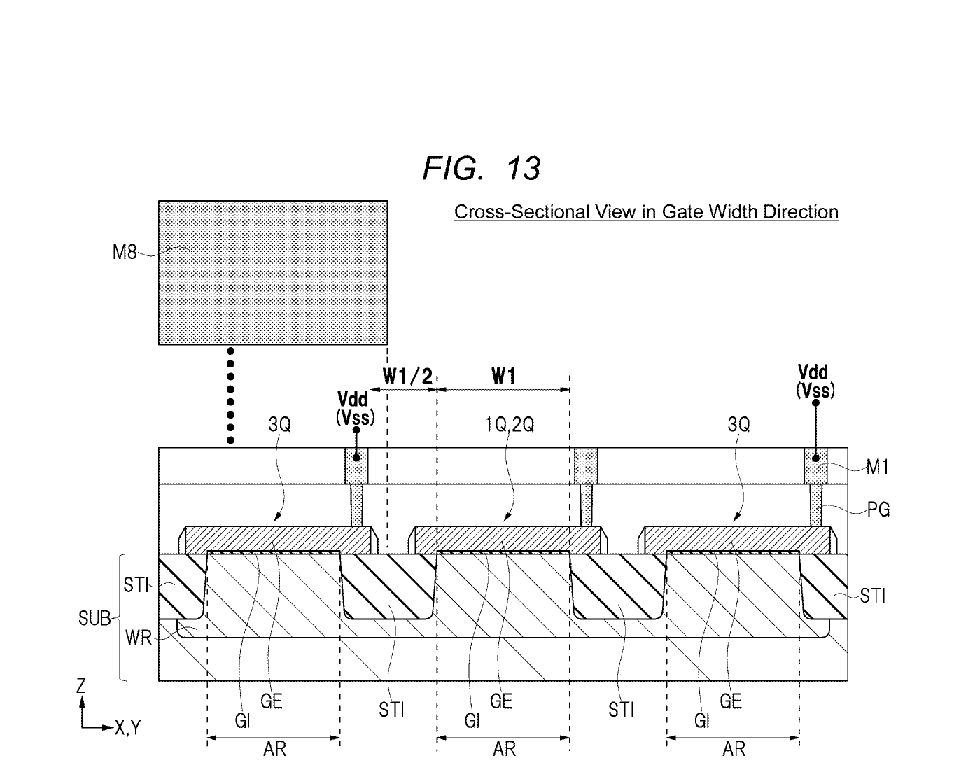

FIGS. 12 and 13 show the cross-sectional structure of MOSFETs constituting MOS units 1Q, 2Q, 3Q. FIG. 12 shows the cross-section in the gate length direction of the MOSFET, and FIG. 13 shows the cross-section in the gate width direction of the MOSFET.

As shown in FIGS. 12 and 13, element isolation section STI is formed in semiconductor substrate SUB. Semiconductor substrate SUB is made of p-type silicon, for example. Element isolation section STI includes a groove formed in semiconductor substrate SUB reaching a predetermined depth from the main surface of semiconductor substrate SUB, and an insulating film embedded inside the groove. The insulation film is a silicon oxide film, for example.

Each MOSFET is formed in the active region AR surrounded by element isolation section STI in plan view of semiconductor substrate SUB. Well region WR is formed in semiconductor substrate SUB. The depth of well region WR is deeper than the depth of element isolation section STI.

In each active region AR, gate electrode GE is formed on well region WR via gate insulating film GI. Gate electrode GE is a polycrystalline silicon film, for example. Impurity region SD is formed in well region WR. Impurity region SD constitutes the source region or drains region of the MOSFET. The location in well region WR positioned between two impurity regions SD and under gate electrode GE becomes the channel region of the MOSFET. Gate electrode GE, impurity region SD, and well region WR are electrically connected to wire M1 by plug PG.

Each MOSFET in the first embodiment is an n-type MOSFET. In this case, well region WR has p-type conductivity, and gate electrode GE and impurity region SD have n-type conductivity. In other embodiments described later, the MOSFETs constituting MOS units 1Q, 2Q, 3Q may be p-type MOSFETs. In a p-type MOSFET, the well region WR has n-type conductivity, and the gate electrode GE and impurity region SD have p-type conductivity.

In the MOSFET constituting the MOS unit 3Q, when the gate electrode GE is electrically connected to the power supply line Vdd, the well region WR and impurity region SD are electrically connected to the ground line Vss, and when the gate electrode GE is electrically connected to the ground line Vss, the well region WR and impurity region SD are electrically connected to the power supply line Vdd.

As shown in FIG. 11, the semiconductor device 100 also includes a control circuit 20 and a register 21, which are configured using multiple MOSFETs as shown in FIGS. 12 and 13.

Here, using FIGS. 12 and 13, the definition of the state where MOS units 1Q, 2Q, and 3Q are covered by wiring M8 will be explained. In the first embodiment, it is considered that MOS units 1Q, 2Q, and 3Q located near the boundary with wiring M8 may be somewhat affected by the stress from wiring M8, and in practice, MOS units 1Q, 2Q, and 3Q that are not covered by wiring M8 may also be defined as being covered by wiring M8.

Let the distance of the active region AR in the gate length direction of the MOSFET be L1, and the distance in the gate width direction be W1. When the MOSFET included in MOS units 1Q, 2Q, 3Q not covered by wiring M8 is formed in an active region AR that is within L1/2 or W1/2 from wiring M8 in plan view, in the first embodiment, those MOS units 1Q, 2Q, 3Q are considered to be covered by wiring M8 in plan view.

### Modified Example 1

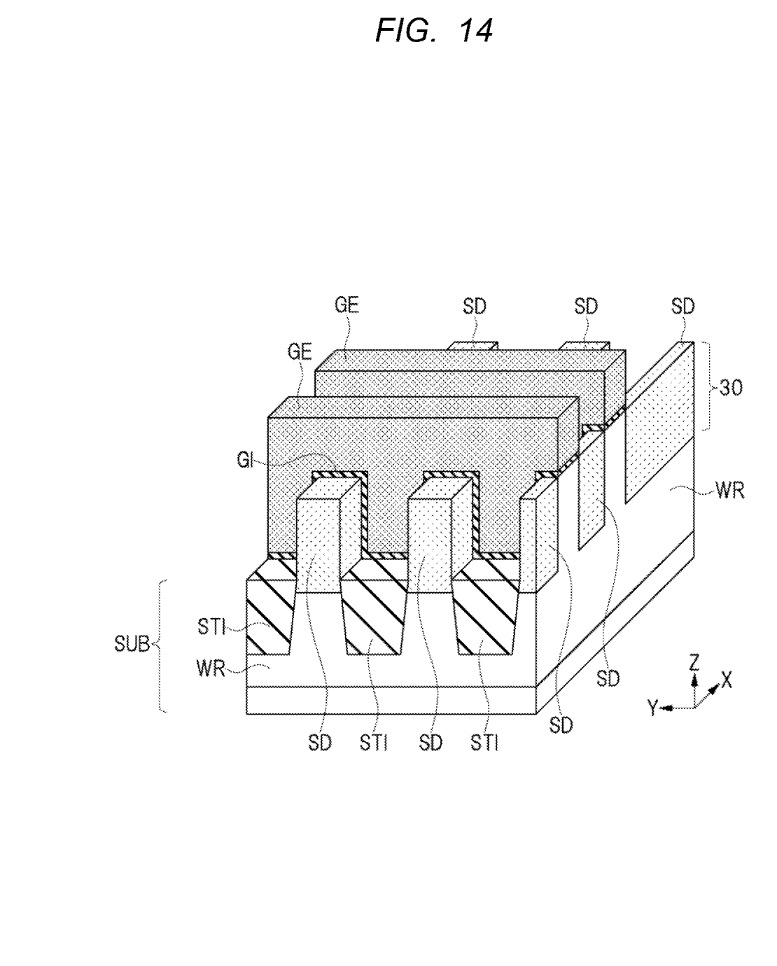

The following describes Modified Example 1 of the first embodiment. In FIGS. 12 and 13, a planar structure MOSFET is illustrated, but the MOSFET may also have a FIN-FET structure. Using FIG. 14, the FIN-FET structure MOSFET will be explained.

As shown in FIG. 14, the semiconductor substrate SUB is provided with multiple protrusions 30, which are part of the semiconductor substrate SUB. The multiple protrusions 30 extend in the X direction and are separated from each other in the Y direction. On the semiconductor substrate SUB located between the multiple protrusions 30, an element isolation region STI is formed. In other words, the space between the multiple protrusions 30 corresponds to a groove formed in the semiconductor substrate SUB, and the element isolation region STI is formed inside the groove. The position of the upper surface of the element isolation region STI is lower than the position of the upper surface of the protrusion 30.

The gate electrode GE extends in the Y direction and is formed to cover the upper surface and both side surfaces of at least one of the multiple protrusions 30. The gate insulating film GI is formed between the gate electrode GE and the protrusion 30. Well region WR is formed in the semiconductor substrate SUB, including the protrusion 30. The impurity region SD is formed in the protrusion 30 exposed from the gate electrode GE (within well region WR).

In the case of a FIN-FET structure, the portion of the well region WR located between the two impurity regions SD that become the source or drain region and covered by the gate electrode GE becomes the channel region of the MOSFET.

In a FIN-FET structure MOSFET, compared to a planar structure MOSFET, more MOSFETs can be arranged in the same planar area, and the gate width per MOSFET can be wider in the same planar area. Therefore, in a FIN-FET structure MOSFET, compared to a planar structure MOSFET, a large amount of drive current can be secured, and the miniaturization of the semiconductor device 100 can be promoted.

### Modified Example 2

The following describes Modified Example 2 of the first embodiment. In the first embodiment, as shown in FIG. 5, when the pitch between each pad electrode PAD (the pitch between each wiring M8) is changed, an example is shown where the pitch is uniformly narrowed with respect to the reference pad electrode PADa.

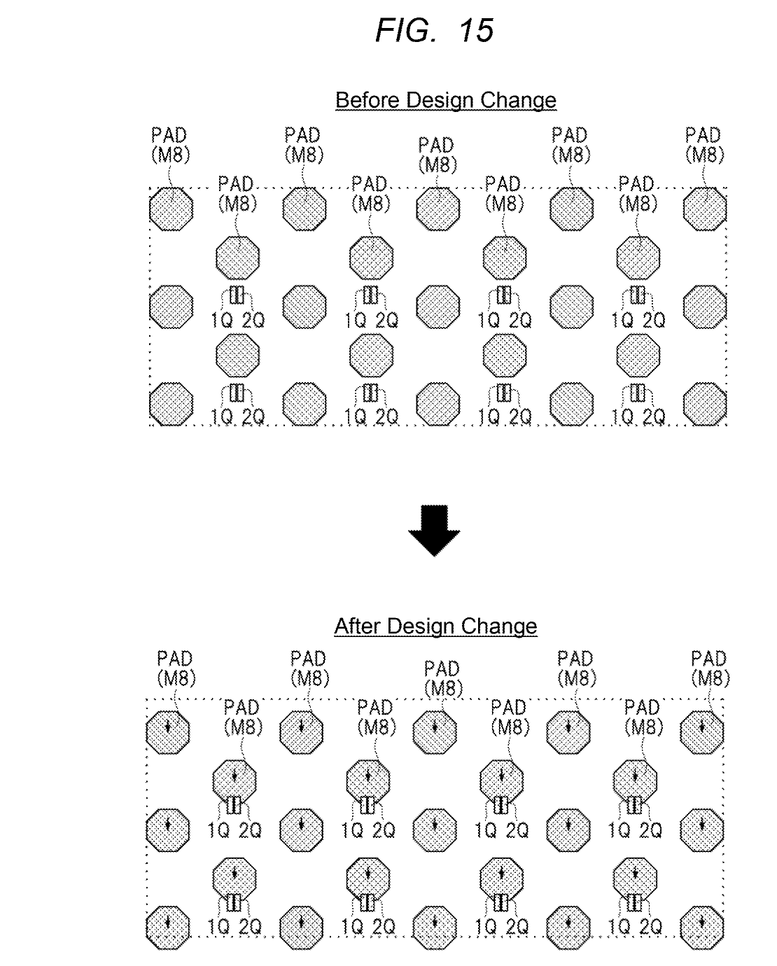

However, as shown in FIG. 15, due to product specifications, the pitch between each pad electrode PAD is not changed, but fine adjustments to the position of each pad electrode PAD may be required. That is, there may be cases where the entire pad electrode PAD is uniformly shifted in the Y direction or X direction. Even in such cases, by preparing multiple MOS units 0Q in advance as candidates for the pair elements (MOS units 1Q, 2Q), characteristic variations of the pair elements can be prevented.

### Second Embodiment

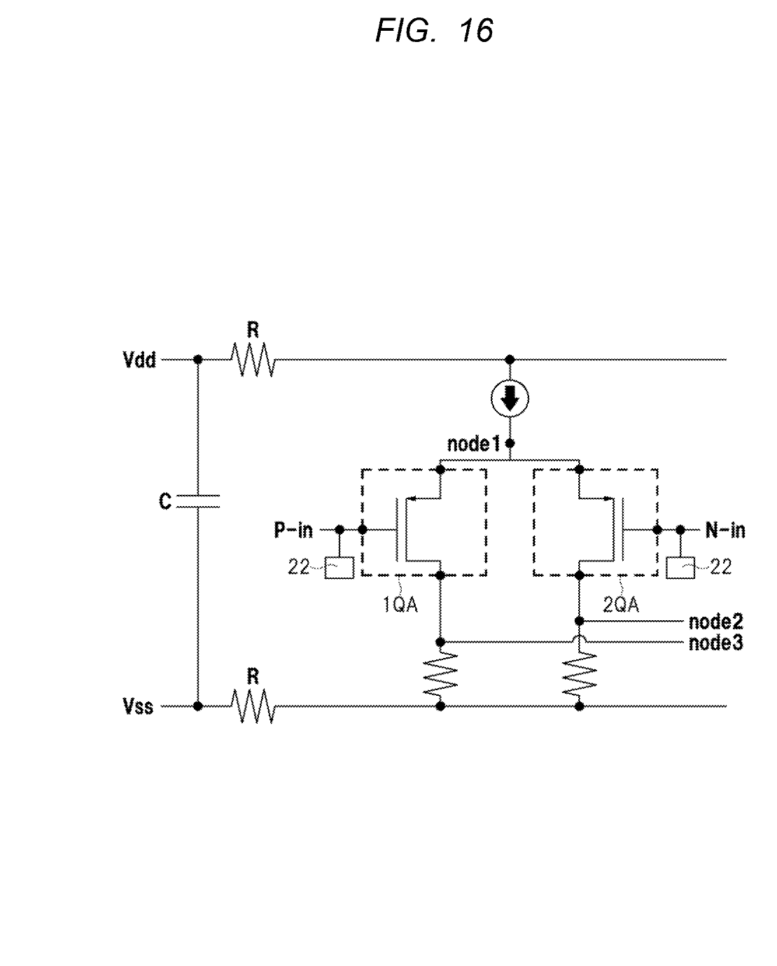

The following describes the semiconductor device 100 in the second embodiment using FIGS. 16 to 21. In the following description, the differences from the first embodiment will be mainly explained, and the points overlapping with the first embodiment will be omitted.

FIG. 16 shows the first stage switch of the differential input circuit as a differential circuit included in the analog IP10 in the second embodiment. MOS unit group 1QA and MOS unit group 2QA form part of the differential circuit as pair elements and are electrically connected to the ESD protection circuit 22.

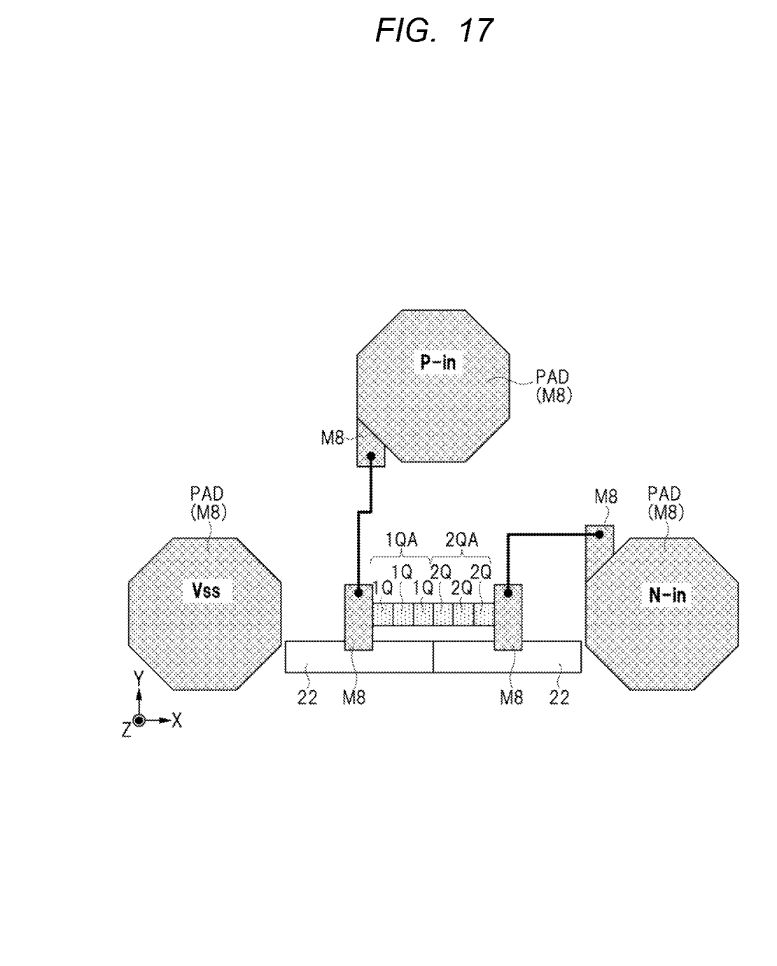

As shown in FIG. 17, MOS unit group 1QA consists of multiple MOS units 1Q, and MOS unit group 2QA consists of multiple MOS units 2Q. The number of multiple MOS units 1Q is equal to the number of multiple MOS units 2Q. In the second embodiment, MOS unit 1Q and MOS unit 2Q are each composed of one p-type MOSFET.

In the equivalent circuit diagram of FIG. 16, MOS unit group 1QA shows a state where multiple MOS units 1Q are connected in parallel, and MOS unit group 2QA shows a state where multiple MOS units 2Q are connected in parallel.

Also, as shown in FIG. 17, another wiring M8, separated from the pad electrode PAD, is provided above MOS unit group 1QA and MOS unit group 2QA to make electrical connections with the ESD protection circuit 22.

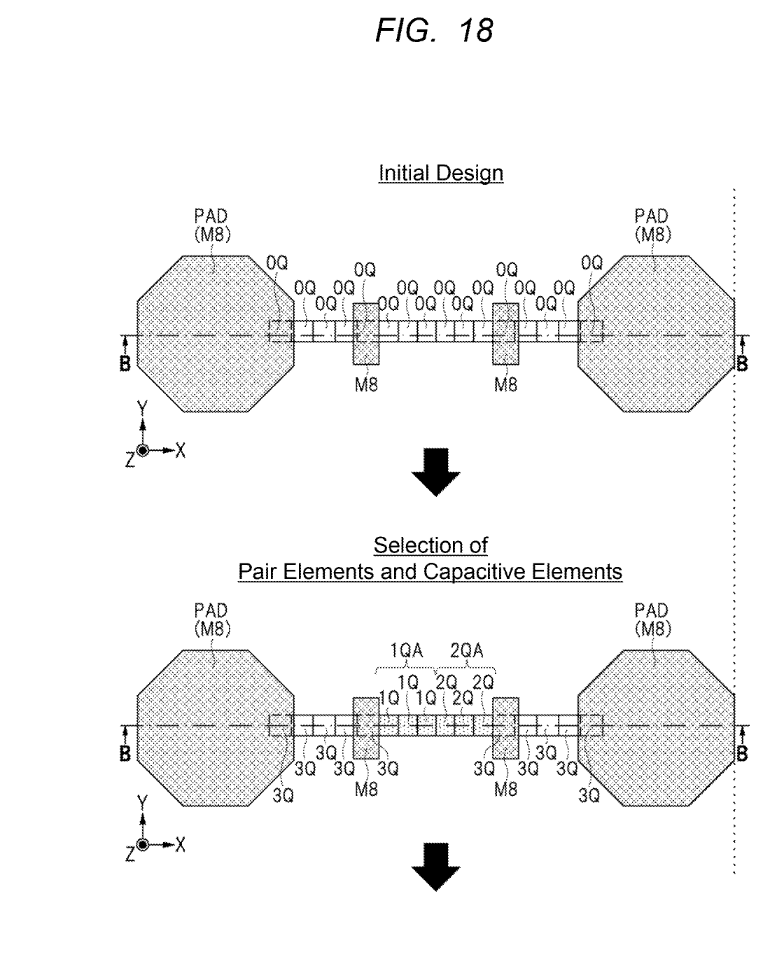

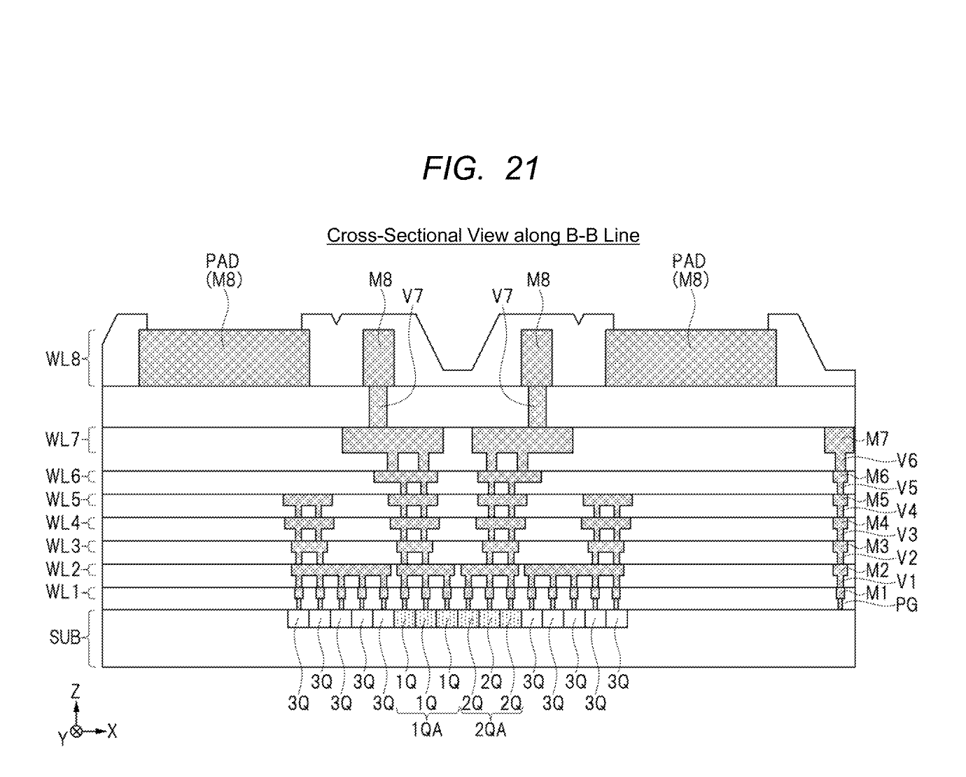

The following describes the design method of the semiconductor device 100 in the second embodiment using FIGS. 18 to 21. FIG. 21 is a cross-sectional view along the B-B line shown in FIG. 18. In the second embodiment, steps S1 to S7 shown in FIG. 7 are carried out in the same manner as in the first embodiment.

First, as shown in the "initial design" of FIG. 18, in step S1, multiple MOS units 0Q, which are arranged adjacent to each other on the main surface of the semiconductor substrate in plan view, are prepared. Each of the multiple MOS units 0Q is composed of one p-type MOSFET.

In step S2, multiple wiring M8 formed in the uppermost wiring layer (wiring layer WL8) of the multilayer wiring layer formed above the multiple MOS units 0Q are prepared. Next, the pitch between each wiring M8 is designed, and the layout of multiple wiring M8 is performed.

Next, as shown in "Selection of Pair Elements and Capacitive Elements" in FIG. 18 and FIG. 21, in step S3, multiple MOS units 1Q and multiple MOS units 2Q, which form part of the differential circuit as pair elements, are selected from multiple MOS units 0Q. Here, the coverage rate of MOS unit group 1QA covered by wiring M8 in plan view is the same as the coverage rate of MOS unit group 2QA covered by wiring M8 in plan view. Therefore, in the second embodiment, as in the first embodiment, characteristic variations of the pair elements do not occur.

In step S4, MOS unit 3Q, which functions as a capacitive element, is selected from the remaining multiple MOS units 0Q. MOS unit 3Q is used as a decoupling capacitor C. In the second embodiment, all MOS units 0Q, except for MOS units 1Q and 2Q, are selected as MOS unit 3Q.

In the second embodiment, the control circuit 20 and register 21 are not used to select multiple MOS units 1Q, 2Q, and 3Q. Instead, multiple wirings formed in the wiring layer below the wiring layer WL8 and used for the connection of the differential circuit are used.

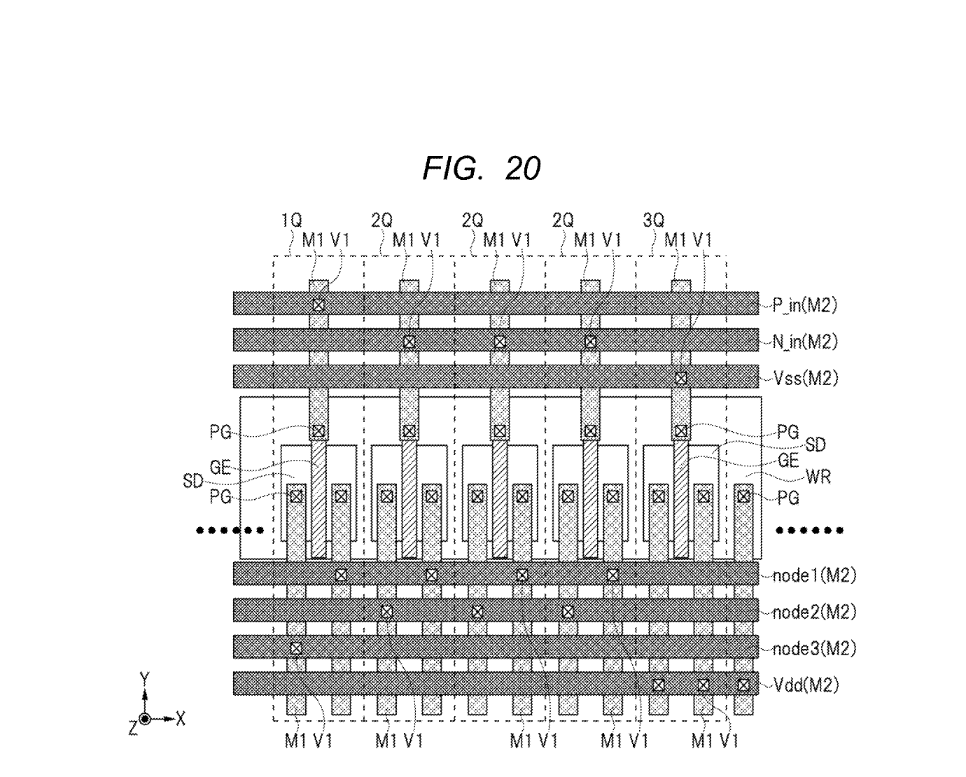

For example, as shown in FIG. 20, the gate electrode GE, well region WR, and impurity region SD of the MOSFET are electrically connected to multiple wirings M1 by plugs PG. Multiple wirings M1 are electrically connected to multiple wirings M2 by vias V1. By changing the arrangement of vias V1 connecting wiring M1 and wiring M2, multiple MOS units 1Q, 2Q, and 3Q can be electrically connected to the wiring corresponding to the equivalent circuit in FIG. 16.

In the case of pair elements where a large current flows, such as the switch of the differential input circuit, using the control circuit 20 may cause the resistance component to affect the characteristics of the pair elements. Therefore, by switching the wiring through the arrangement change of vias V1, the influence of the resistance component on the current path of the differential input circuit can be avoided. Moreover, such a configuration can minimize the wiring load connected to the pair elements.

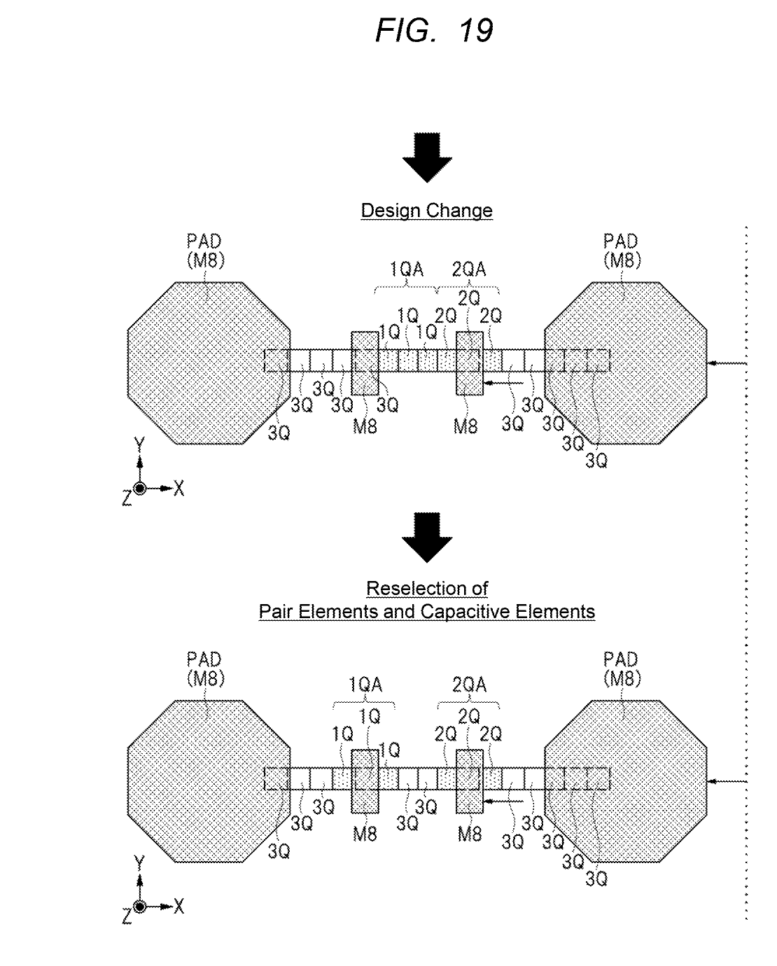

Subsequently, as shown in "Design Change" in FIG. 19, the pitch between each wiring M8 may be changed. When the pitch between each wiring M8 is changed in step S5 (YES), multiple MOS units 1Q and multiple MOS units 2Q are reselected in step S6.

As shown in "Reselection of Pair Elements and Capacitive Elements" in FIG. 19, in step S6, multiple MOS units 1Q and multiple MOS units 2Q are reselected from multiple MOS units 0Q so that the coverage rate of MOS unit group 1QA and the coverage rate of MOS unit group 2QA are the same.

In step S7, MOS unit 3Q is reselected from the remaining MOS units 0Q. In step S7, similar to step S4, all MOS units 0Q excluding MOS units 1Q and 2Q are reselected as MOS unit 3Q.

Thus, in embodiment 2, similar to embodiment 1, even when the pitch between each wiring M8 is changed, multiple MOS units 1Q and multiple MOS units 2Q can be reselected, preventing characteristic variations of the pair elements.

Also, in embodiment 2, similar to embodiment 1, a capacitive element for decoupling capacitance C can be placed near the pair elements, MOS unit group 1QA and MOS unit group 2QA, reducing the wiring resistance R between the pair elements and decoupling capacitance C, decreasing the amplitude of the power supply waveform, and improving the responsiveness of the decoupling capacitance C. That is, the performance of the differential circuit can be improved.

### Third Embodiment

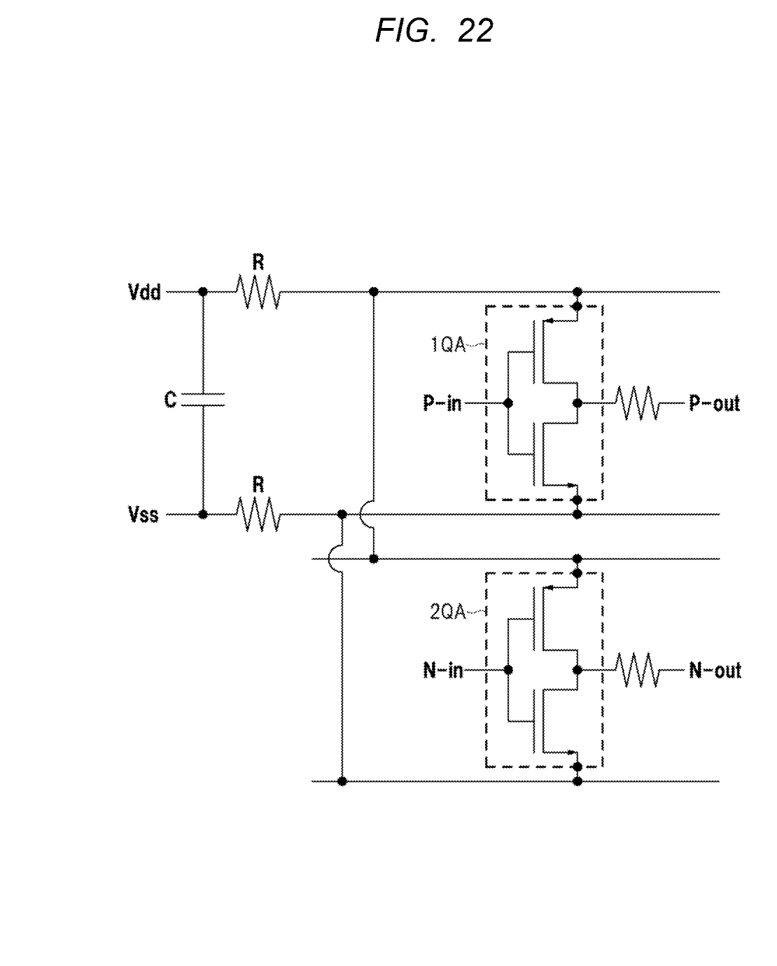

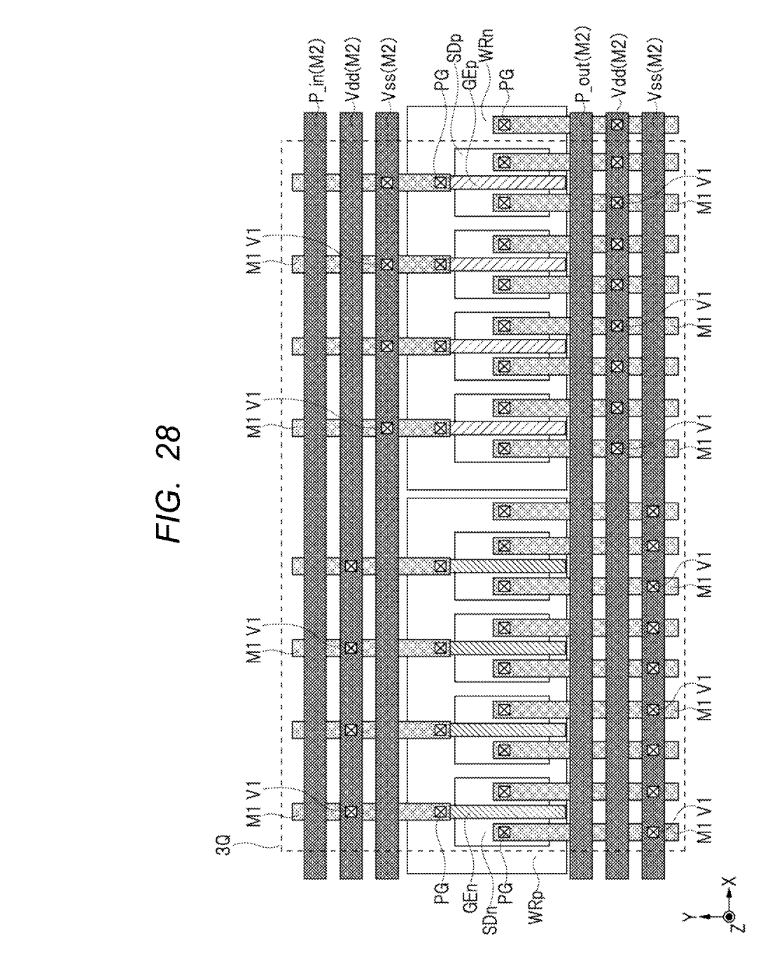

Below, the semiconductor device 100 in the third embodiment will be described using FIGS. 22 to 29. In the following description, the differences from embodiments 1 and 2 will be mainly explained, and the points overlapping with embodiments 1 and 2 will be omitted.

FIG. 22 shows a differential output circuit as a differential circuit included in the analog IP10 in the third embodiment. MOS unit group 1QA and MOS unit group 2QA constitute part of the differential circuit as pair elements.

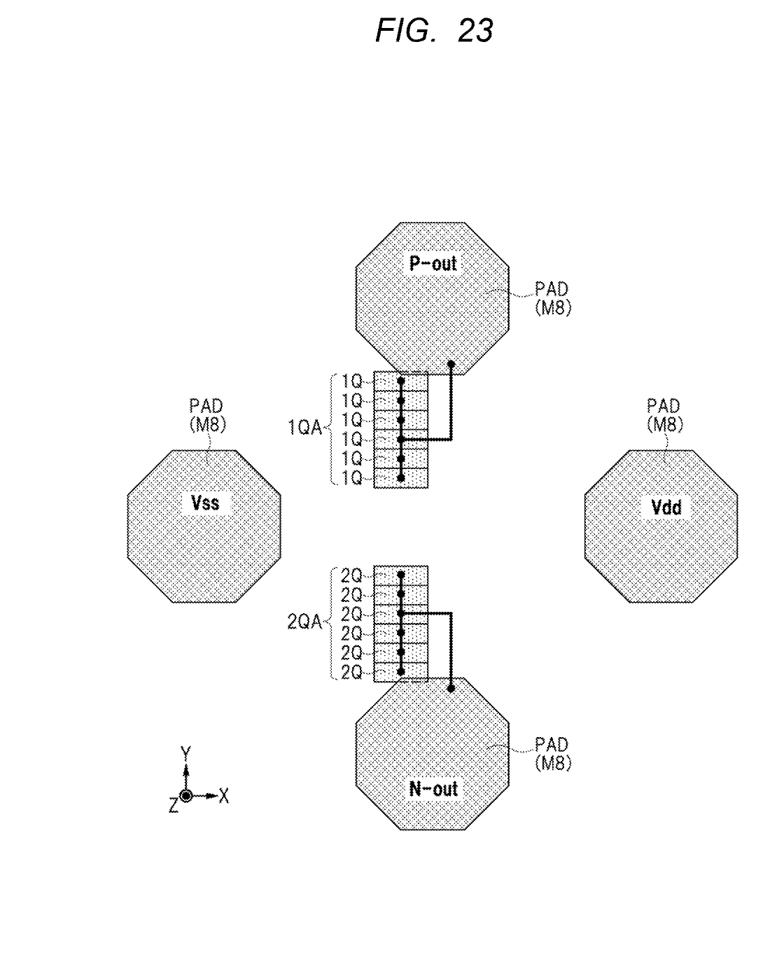

As shown in FIG. 23, MOS unit group 1QA consists of multiple MOS units 1Q, and MOS unit group 2QA consists of multiple MOS units 2Q. The number of multiple MOS units 1Q is equal to the number of multiple MOS units 2Q.

In the equivalent circuit diagram of FIG. 22, MOS unit group 1QA shows a state where multiple MOS units 1Q are connected in parallel, and MOS unit group 2QA shows a state where multiple MOS units 2Q are connected in parallel.

In the case of a differential output circuit like FIG. 23, since the size of each MOS unit group 1QA and MOS unit group 2QA is relatively large, part of each of MOS unit group 1QA and MOS unit group 2QA is easily covered by the pad electrode PAD. The coverage rate of MOS unit group 1QA and the coverage rate of MOS unit group 2QA are made the same to prevent characteristic variations of the pair elements.

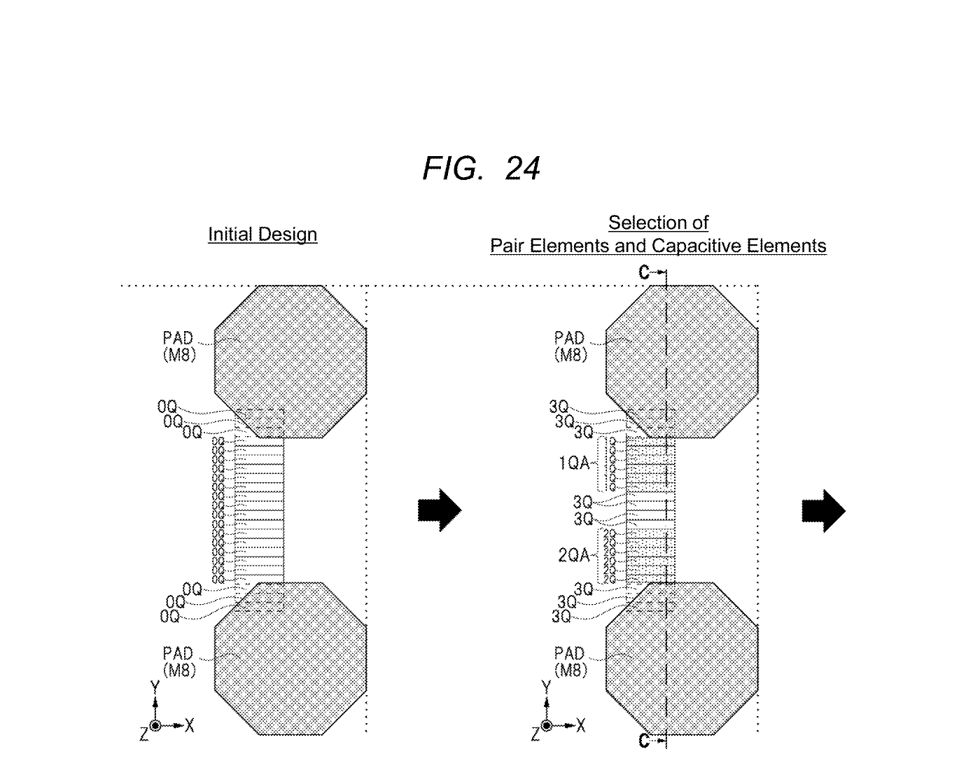

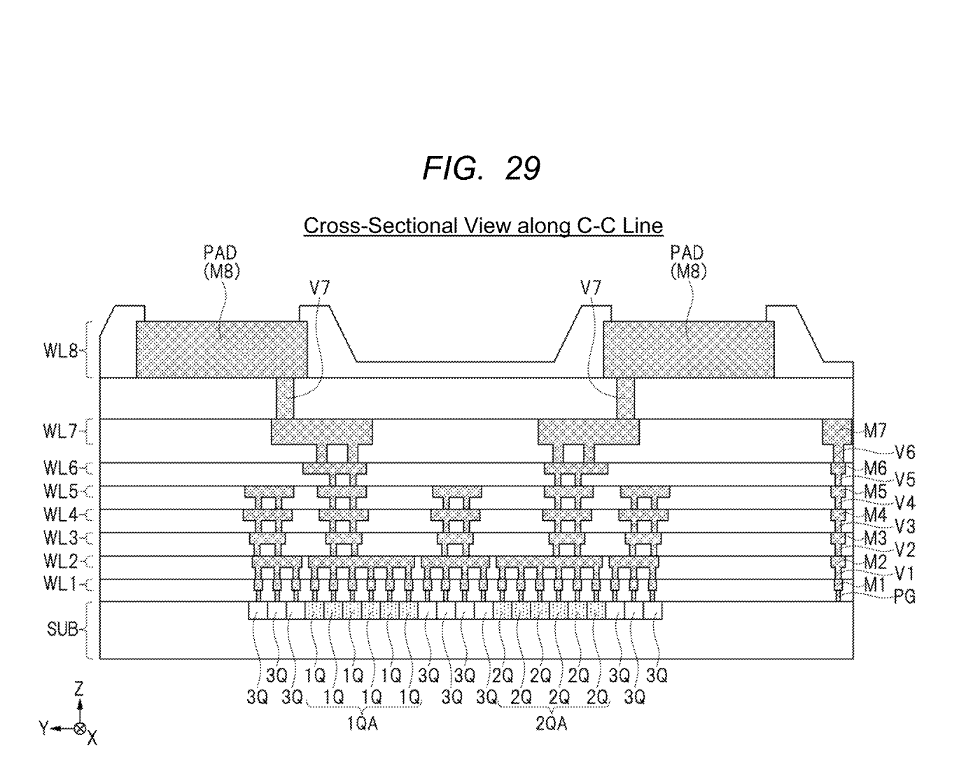

Below, the design method of the semiconductor device 100 in the third embodiment will be described using FIGS. 24 to 29. FIG. 29 is a cross-sectional view along the C-C line shown in FIG. 23. In the third embodiment, steps S1 to S7 shown in FIG. 7 are carried out with the same intent as in the first embodiment.

First, as shown in "Initial Design" in FIG. 24, in step S1, multiple MOS units 0Q arranged adjacent to each other on the main surface of the semiconductor substrate are prepared in plan view.

Next, in step S2, multiple wiring M8 formed in the uppermost wiring layer (wiring layer WL8) of the multilayer wiring layers formed above the multiple MOS units 0Q are prepared. Next, the pitch between each wiring M8 is designed, and the layout of multiple wiring M8 is performed.

Next, as shown in "Selection of Pair Elements and Capacitive Elements" in FIG. 24 and FIG. 29, in step S3, multiple MOS units 1Q and multiple MOS units 2Q, which constitute part of the differential circuit as pair elements, are selected from multiple MOS units 0Q. Here, the coverage rate of MOS unit group 1QA covered by wiring M8 in plan view is the same as the coverage rate of MOS unit group 2QA covered by wiring M8 in plan view. Therefore, in the third embodiment, similar to the first embodiment, characteristic variations of the pair elements do not occur.

In step S4, MOS unit 3Q, which functions as a capacitive element, is selected from the remaining multiple MOS units 0Q. MOS unit 3Q is used as decoupling capacitance C. In the third embodiment, all MOS units 0Q excluding MOS units 1Q and 2Q are selected as MOS unit 3Q.

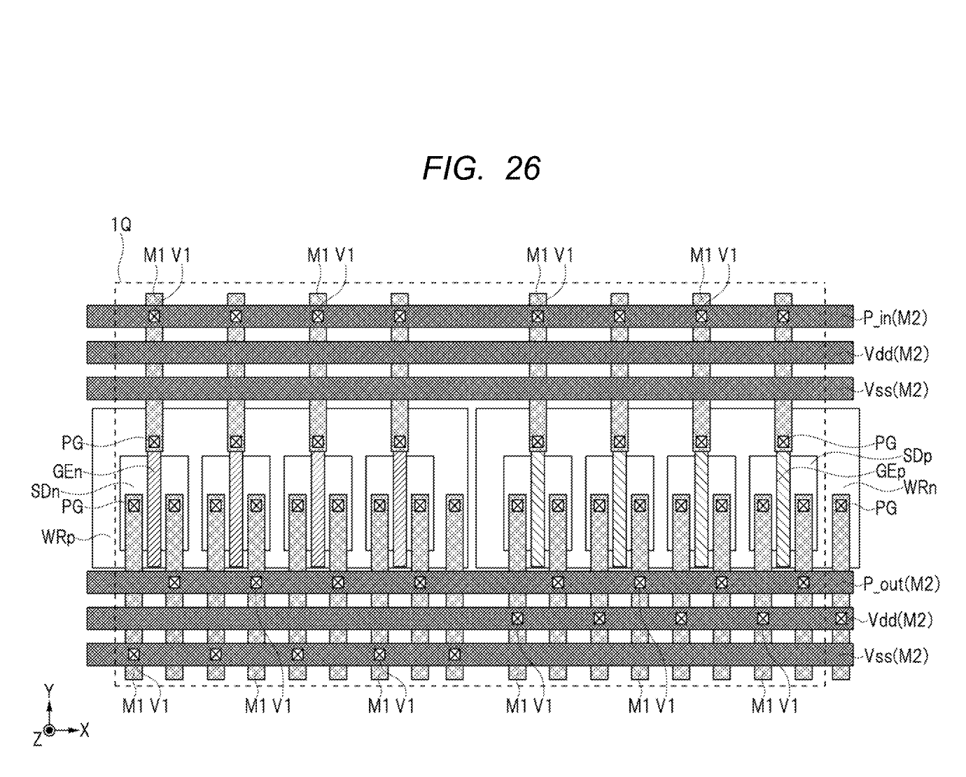

As shown in FIGS. 26, 27, and 28, multiple MOS units 1Q, 2Q, and 3Q in the third embodiment are each composed of one or more n-type MOSFETs and one or more p-type MOSFETs. The number of one or more n-type MOSFETs is the same as the number of one or more p-type MOSFETs.

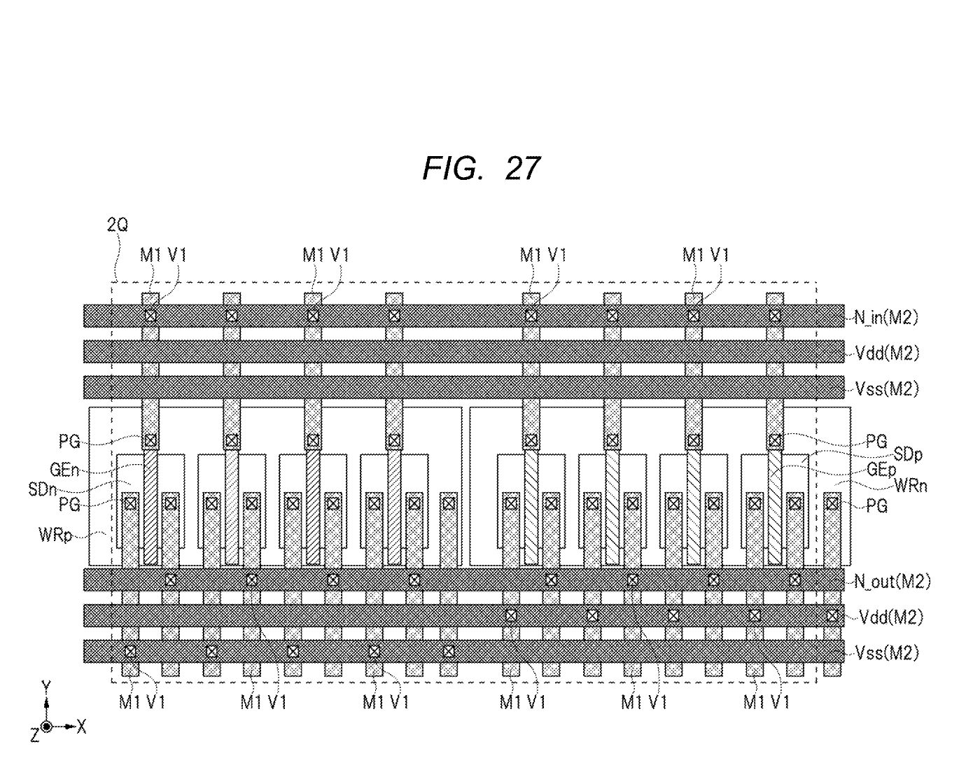

The n-type MOSFET has a p-type well region WRp, an n-type gate electrode GEn, and two impurity regions SDn that become the source or drain region. The p-type MOSFET has an n-type well region WRn, a p-type gate electrode GEp, and two impurity regions SDp that become the source or drain region. As shown in FIGS. 26 and 27, in MOS units 1Q and 2Q, one or more n-type MOSFETs and one or more p-type MOSFETs are connected in an inverter configuration.

In the third embodiment, similar to the second embodiment, multiple wirings formed in a wiring layer lower than wiring layer WL8 and used for the connection of the differential circuit are used to select multiple MOS units 1Q, 2Q, and 3Q.

For example, as shown in FIGS. 26, 27, and 28, the gate electrode GEn, well region WRp, and impurity region SDn of the n-type MOSFET, and the gate electrode GEp, well region WRn, and impurity region SDp of the p-type MOSFET are electrically connected to multiple wirings M1 by plugs PG. Multiple wirings M1 are electrically connected to multiple wirings M2 by vias V1. By changing the arrangement of vias V1 connecting wiring M1 and wiring M2, multiple MOS units 1Q, 2Q, and 3Q can be electrically connected to the wiring corresponding to the equivalent circuit in FIG. 22.

The differential output circuit of the third embodiment also carries a large current, similar to the differential input circuit of the second embodiment. Therefore, by switching the wiring through the arrangement change of vias V1, the influence of the resistance component on the current path of the differential output circuit can be avoided. Moreover, such a configuration can minimize the wiring load connected to the pair elements.

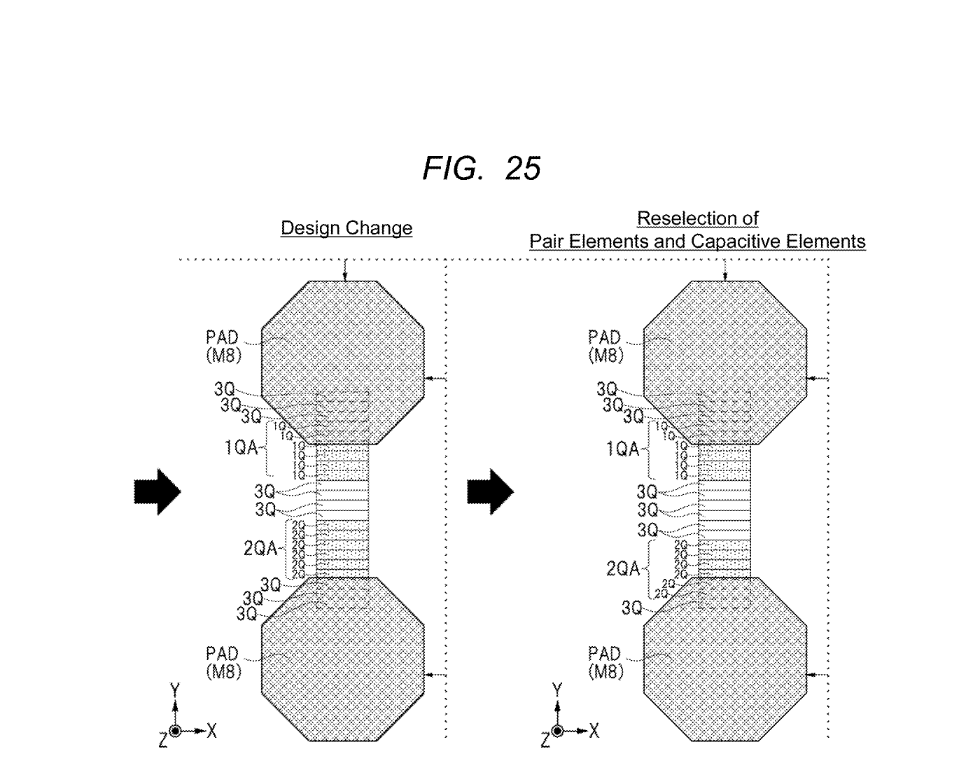

Subsequently, as shown in "Design Change" in FIG. 25, there may be cases where the pitch between each wiring M8 is changed. In step S5, when the pitch between each wiring M8 is changed (YES), multiple MOS units 1Q and multiple MOS units 2Q are reselected in step S6.

As shown in "Reselection of Pair Elements and Capacitive Elements" in FIG. 25, in step S6, multiple MOS units 1Q and multiple MOS units 2Q are reselected from multiple MOS units 0Q so that the coverage rate of MOS unit group 1QA and the coverage rate of MOS unit group 2QA are the same.

In step S7, MOS unit 3Q is reselected from the remaining MOS units 0Q. In step S7, similar to step S4, all MOS units 0Q excluding MOS units 1Q and 2Q are reselected as MOS unit 3Q.

Thus, in the third embodiment, similar to embodiments 1 and 2, even when the pitch between each wiring M8 is changed, multiple MOS units 1Q and multiple MOS units 2Q can be reselected, preventing characteristic variations of the pair elements.

Also, in the third embodiment, similar to embodiments 1 and 2, a capacitive element for decoupling capacitance C can be placed near the pair elements, MOS unit group 1QA and MOS unit group 2QA, reducing the wiring resistance R between the pair elements and decoupling capacitance C, decreasing the amplitude of the power supply waveform, and improving the responsiveness of the decoupling capacitance C. That is, the performance of the differential circuit can be improved.

### Fourth Embodiment

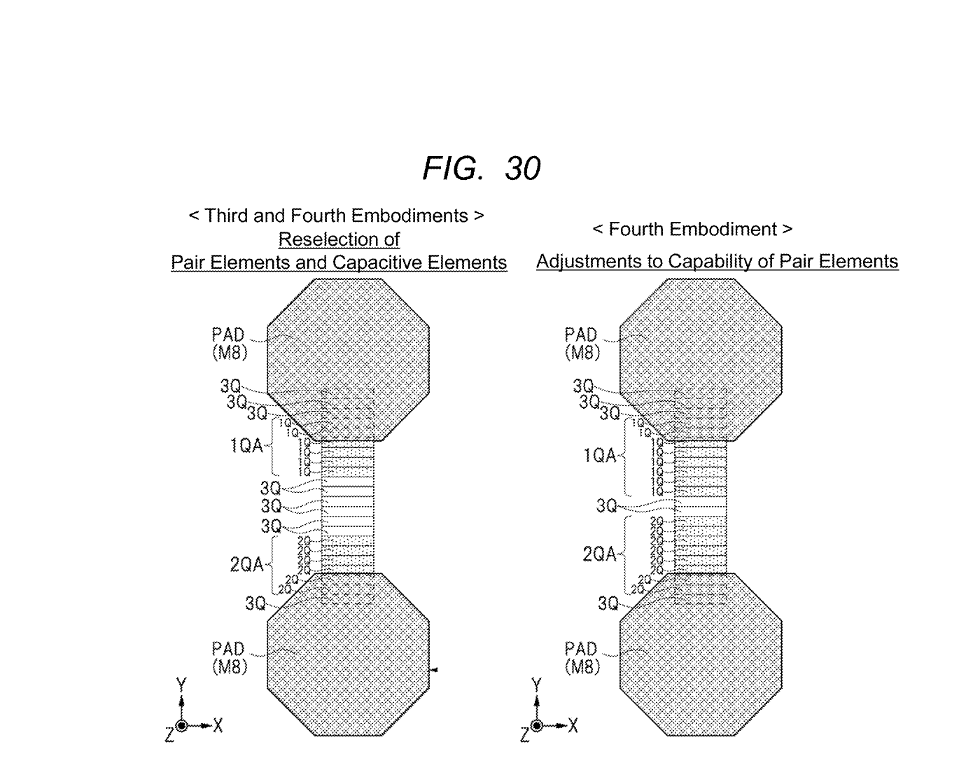

Below, the design method of the semiconductor device 100 in the fourth embodiment will be described using FIG. 30. In the following description, the differences from embodiments 1 to 3 will be mainly explained, and the points overlapping with embodiments 1 to 3 will be omitted.

In the fourth embodiment, part of the remaining MOS units 0Q in step S6 is also used as an element for adjusting the capability of the differential circuit. For example, even with the same analog IP10, fine adjustments to the capability of the differential circuit may be required based on individual customer requirements. In such cases, technology that can respond flexibly and promptly is provided.

That is, as illustrated in the third embodiment, as shown in FIG. 30, after step S6 in FIG. 7, at least one or more MOS units 1Q are added to MOS unit group 1QA from multiple MOS units 0Q, and the same number of added MOS units 1Q are added as MOS units 2Q to MOS unit group 2QA from multiple MOS units 0Q. Thus, by adding part of the remaining MOS units 0Q as MOS units 1Q and 2Q to the differential circuit, fine adjustments to the capability of the differential circuit can be made. In step S7, all the remaining multiple MOS units 0Q after fine adjustment are reselected as MOS units 3Q.

### Fifth Embodiment

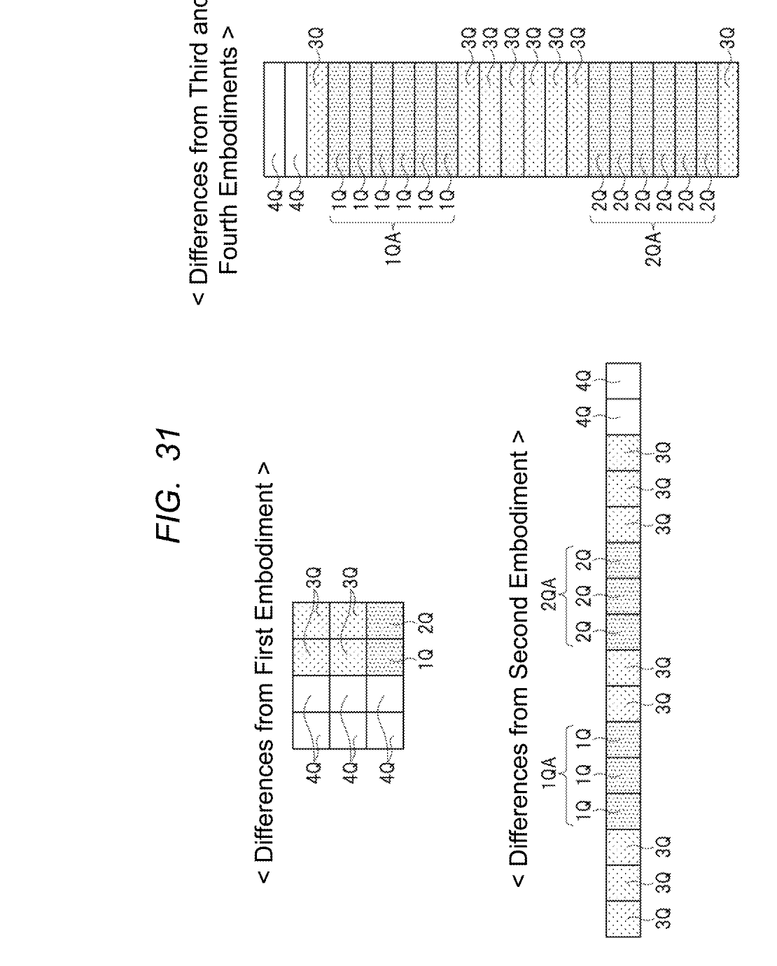

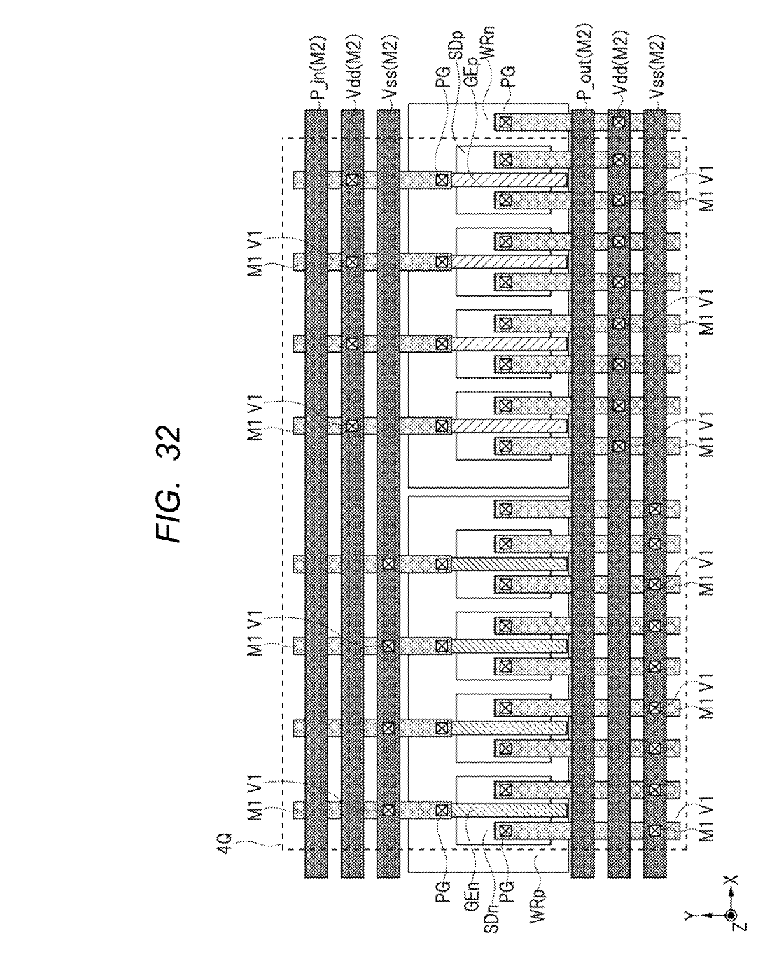

Below, the semiconductor device 100 in the fifth embodiment will be described with reference to FIGS. 31 and 32. In the following description, the differences from the first to the fourth embodiments will be mainly explained, and the overlapping points with the first to the fourth embodiments will be omitted.

In the first to fourth embodiments, in steps S4 and S7, all MOS units 0Q except for MOS unit 1Q (MOS unit group 1QA) and MOS unit 2Q (MOS unit group 2QA) were selected as MOS units 3Q. That is, there were cases where the number and arrangement configuration of multiple MOS units 3Q arranged around MOS unit 1Q were unequal to the number and arrangement configuration of multiple MOS units 3Q arranged around MOS unit 2Q. Hereinafter, such an arrangement of multiple MOS units 3Q is referred to as "unequal arrangement".

As shown in FIG. 31, in the fifth embodiment, in steps S4 and S7, multiple MOS units 3Q are selected from the remaining multiple MOS units 0Q. At this time, the number and arrangement configuration of multiple MOS units 3Q arranged around MOS unit 1Q (MOS unit group 1QA) are equal to the number and arrangement configuration of multiple MOS units 3Q arranged around MOS unit 2Q (MOS unit group 2QA). Here, equality means that the total capacitance around MOS unit 1Q (MOS unit group 1QA) is equal to the total capacitance around MOS unit 2Q (MOS unit group 2QA). Hereinafter, such an arrangement of multiple MOS units 3Q is referred to as "equal arrangement".

Therefore, after step S4 and step S7, all the remaining multiple MOS units 0Q may become MOS units 3Q, but one or more MOS units 0Q may remain further. In the fifth embodiment, when one or more MOS units 0Q remain further, all of the one or more MOS units 0Q are made into unused MOS units 4Q. Unused MOS units 4Q are not used in capacitive elements, differential circuits, and other circuits.

FIG. 32 shows an example of making MOS unit 4Q unused. As shown in FIG. 32, in the n-type MOSFET constituting MOS unit 4Q, the gate electrode GEn, well region WRp, and impurity region SDn are electrically connected to the ground wiring Vss. In the p-type MOSFET constituting MOS unit 4Q, the gate electrode GEp, well region WRn, and impurity region SDp are electrically connected to the power supply wiring Vdd.

In circuits that perform high-speed operations such as differential output circuits, there are standards regarding Jitter, and it is desirable to reduce Jitter. Jitter is a phenomenon where the arrival time of a signal waveform deviates from the original time. Factors that increase Jitter include noise, power supply fluctuations, temperature changes, or manufacturing variations.

The responsiveness of capacitance is determined by the CR time constant. The present inventors have found that by arranging multiple MOS units 3Q equally with respect to MOS unit 1Q (MOS unit group 1QA) and MOS unit 2Q (MOS unit group 2QA), Jitter can be reduced.

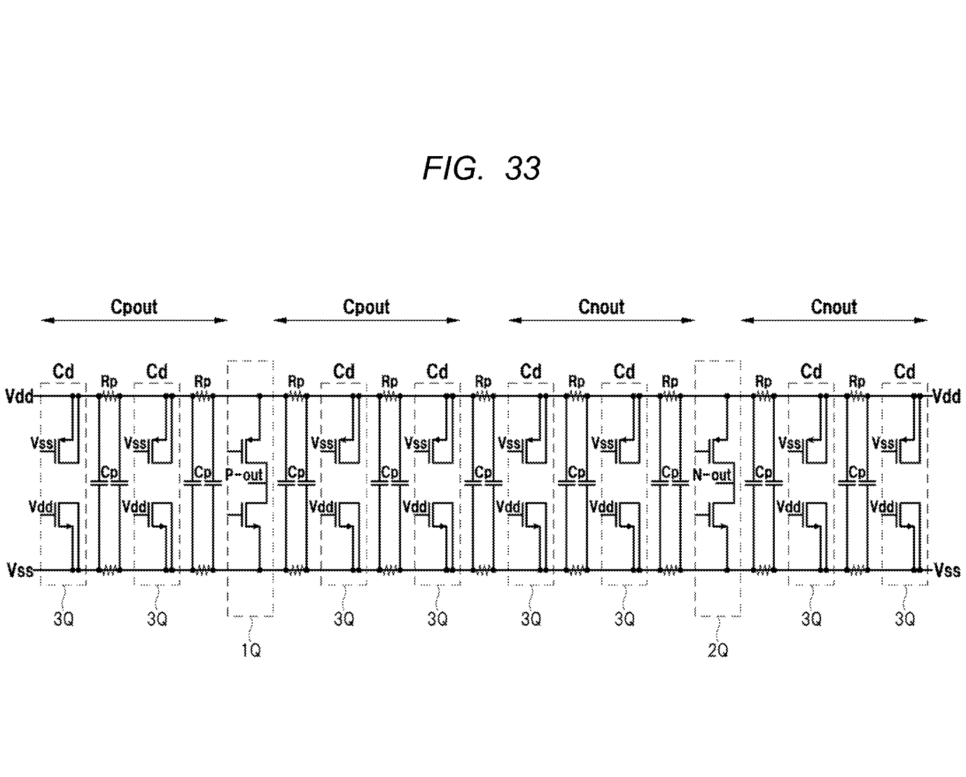

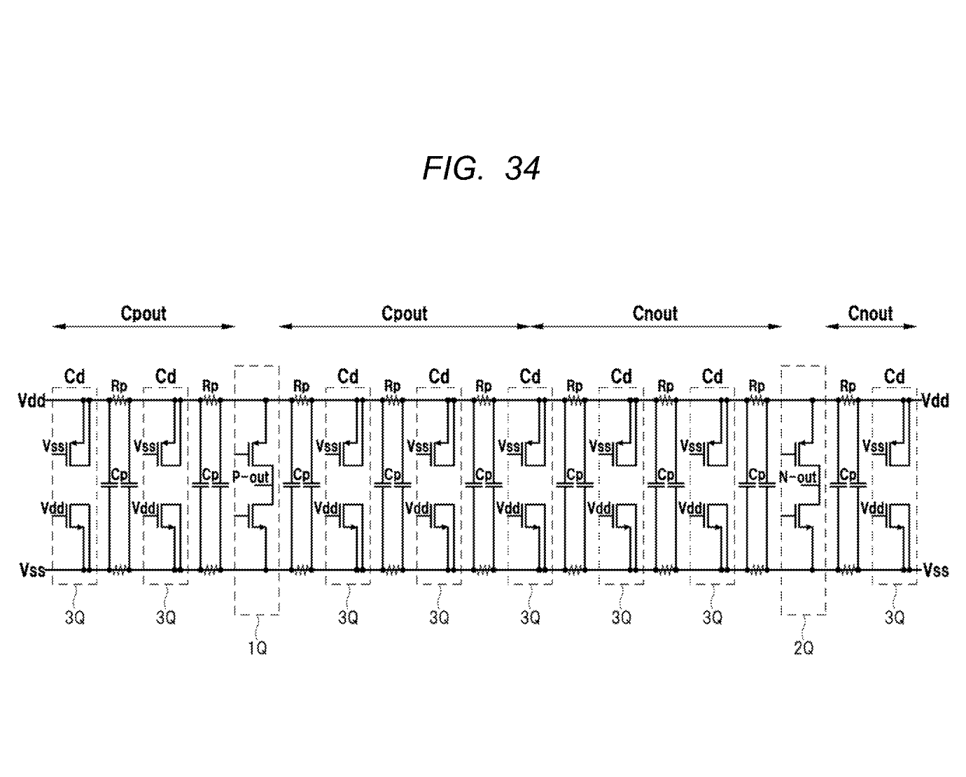

FIGS. 33 and 34 show equivalent circuit diagrams when a decoupling capacitance C composed of multiple MOS units 3Q is arranged for pair elements (P-out, N-out) of a differential output circuit as shown in FIG. 22. FIG. 33 shows the case where multiple MOS units 3Q are equally arranged. FIG. 34 shows the case where multiple MOS units 3Q are unequally arranged. In FIGS. 33 and 34, each parasitic capacitance Cp, each resistance component Rp, and each decoupling capacitance component Cd are equal, and the capacitance value between P-out and N-out is divided in half.

In FIG. 33, the total capacitance value Cpout for P-out is (4×Cd+4×Cp), and the total capacitance value Cnout for N-out is (4×Cd+4×Cp). Therefore, the total capacitance value Cpout is equal to the total capacitance value Cnout.

In FIG. 34, the total capacitance value Cpout for P-out is (4.5×Cd+5×Cp), and the total capacitance value Cnout for N-out is (3.5×Cd+4×Cp). Therefore, the total capacitance value Cpout is unequal to the total capacitance value Cnout.

For example, when the Jitter in FIG. 33 is 0.1ps, the Jitter in FIG. 34 is 0.5ps. Thus, by arranging multiple MOS units 3Q equally for the pair elements, Jitter can be reduced, and the performance of the differential circuit can be improved.

Although the present invention has been specifically described based on the above embodiments, the present invention is not limited to the above embodiments, and various modifications can be made without departing from the gist thereof.

What is claimed is:

1. A semiconductor device comprising:
a semiconductor substrate having a first surface; and
a plurality of MOS units each composed of at least one MOSFET, each having the same structure, and arranged adjacent to each other on the first surface of the semiconductor substrate in plan view when viewed from above the first surface of the semiconductor substrate,
wherein the plurality of MOS units include a first MOS unit and a second MOS unit that constitute part of a differential circuit as pair elements, and a third MOS unit that functions as a capacitive element.

2. The semiconductor device according to claim 1, further
comprising:
power supply wiring and ground wiring used in the differential circuit,
wherein the third MOS unit is used as a decoupling capacitance electrically connected between the power supply wiring and the ground wiring.

3. The semiconductor device according to claim 2,
wherein the MOSFET comprises:
a first conductivity type well region formed in the semiconductor substrate;
a source region of a second conductivity type opposite to the first conductivity type formed in the well region;
a drain region of the second conductivity type formed in the well region; and
a gate electrode formed on the well region via a gate insulating film,
wherein when the first conductivity type is n-type, the second conductivity type is p-type,
wherein when the first conductivity type is p-type, the second conductivity type is n-type, and
wherein, in the MOSFET constituting the third MOS unit, when the gate electrode is electrically connected to the power supply wiring, the well region, the source region, and the drain region are electrically connected to the ground wiring, and when the gate electrode is electrically connected to the ground wiring, the well region, the source region, and the drain region are electrically connected to the power supply wiring.

4. The semiconductor device according to claim 1,
wherein all the MOS units except for the first MOS unit and the second MOS unit among the plurality of MOS units are the third MOS unit.

5. The semiconductor device according to claim 1,
wherein the plurality of MOS units include a plurality of the third MOS units, and
wherein the number and arrangement configuration of the plurality of the third MOS units arranged around the first MOS unit are equal to the number and arrangement configuration of the plurality of the third MOS units arranged around the second MOS unit.

6. The semiconductor device according to claim 5,
wherein the plurality of MOS units further includes a fourth MOS unit not used in the capacitive element, the differential circuit, and other circuits.

7. The semiconductor device according to claim 1, further
comprising:
a multilayer wiring layer formed above the plurality of MOS units; and
a first wiring formed in the uppermost wiring layer of the multilayer wiring layer,
wherein the coverage rate of the first MOS unit covered by the first wiring in plan view is the same as the coverage rate of the second MOS unit covered by the first wiring in plan view.

8. The semiconductor device according to claim 7,
wherein each of the plurality of MOS units is composed of one n-type MOSFET or one p-type MOSFET.

9. The semiconductor device according to claim 7,
wherein each of the plurality of MOS units is composed of one or more n-type MOSFETs and one or more p-type MOSFETs,
wherein the number of the one or more n-type MOSFETs is the same as the number of the one or more p-type MOSFETs, and
wherein, in the first MOS unit and the second MOS unit, the one or more n-type MOSFETs and the one or more p-type MOSFETs are inverter-connected.

10. The semiconductor device according to claim 7,
wherein the first MOS unit and the second MOS unit included in the plurality of MOS units are each multiple,
wherein the number of the plurality of the first MOS units is equal to the number of the plurality of the second MOS units, and
wherein when the plurality of the first MOS units are grouped as the first MOS unit group and the plurality of the second MOS units are grouped as the second MOS unit group, the coverage rate of the first MOS unit group covered by the first wiring in plan view is the same as the coverage rate of the second MOS unit group covered by the first wiring in plan view.

11. A method of designing a semiconductor device comprising:
(a) preparing a plurality of MOS units, each composed of at least one MOSFET, each having the same structure, and arranged adjacent to each other on the first surface of the semiconductor substrate in plan view when viewed from above the first surface of the semiconductor substrate;
(b) selecting a first MOS unit and a second MOS unit from the plurality of MOS units, which constitute part of a differential circuit as pair elements; and
(c) selecting a third MOS unit that functions as a capacitive element from the plurality of MOS units remaining after the step (b).

12. The method of designing the semiconductor device according to claim 11, further comprising:
(d) preparing power wiring and ground wiring used in the differential circuit,
wherein the third MOS unit is used as a decoupling capacitance electrically connected between the power wiring and the ground wiring.

13. The method of designing the semiconductor device according to claim 12,
wherein the MOSFET comprises:
a well region of a first conductivity type formed in the semiconductor substrate,
a source region of a second conductivity type opposite to the first conductivity type formed in the well region,
a drain region of the second conductivity type formed in the well region, and
a gate electrode formed on the well region via a gate insulating film,
wherein when the first conductivity type is n-type, the second conductivity type is p-type,
wherein when the first conductivity type is p-type, the second conductivity type is n-type,
wherein, in the MOSFET constituting the third MOS unit, when the gate electrode is electrically connected to the ground wiring, the well region, the source region, and the drain region are electrically connected to the power wiring, and when the gate electrode is electrically connected to the power wiring, the well region, the source region, and the drain region are electrically connected to the ground wiring.

14. The method of designing the semiconductor device according to claim 11,
wherein, in step (c), all the MOS units except the first MOS unit and the second MOS unit from the plurality of MOS units are selected as the third MOS unit.

15. The method of designing the semiconductor device according to claim 11,
wherein, in the step (c), a plurality of the third MOS units are selected from the plurality of MOS units remaining after the step (b), and
wherein the number and arrangement configuration of the plurality of the third MOS units arranged around the first MOS unit are equal to the number and arrangement configuration of the plurality of the third MOS units arranged around the second MOS unit.

16. The method of designing the semiconductor device according to claim 15,
wherein when one or more of the MOS units remain after step (c), all of the one or more MOS units are made into a fourth MOS unit not used in the capacitive element, the differential circuit, and other circuits.

17. The method of designing the semiconductor device according to claim 11, further comprising:
(e) preparing a first wiring formed in the uppermost wiring layer among the multilayer wiring layers formed above the plurality of MOS units before the step (b),
wherein in the step (b), the first MOS unit and the second MOS unit are selected from the plurality of MOS units such that the coverage rate of the first MOS unit covered by the first wiring in plan view is the same as the coverage rate of the second MOS unit covered by the first wiring in plan view.

18. The method of designing the semiconductor device according to claim 17, further comprising:
(f) reselecting the first MOS unit and the second MOS unit from the plurality of MOS units such that the coverage rate of the first MOS unit and the coverage rate of the second MOS unit are the same when the pitch between each wiring formed in the uppermost wiring layer is changed after the step (b) and the step (c), and
(g) reselecting the third MOS unit from the plurality of MOS units remaining after the step (f).

19. The method of designing the semiconductor device according to claim 17,
wherein each of the plurality of MOS units is composed of one n-type MOSFET or one p-type MOSFET.

20. The method of designing the semiconductor device according to claim 17,
wherein each of the plurality of MOS units is composed of one or more n-type MOSFETs and one or more p-type MOSFETs,
wherein the number of the one or more n-type MOSFETs is the same as the number of the one or more p-type MOSFETs, and
wherein, in the first MOS unit and the second MOS unit, the one or more n-type MOSFETs and the one or more p-type MOSFETs are inverter-connected.
